(19) United States
(12) Patent Application Publication
(10) Pub. No.: US 2026/0070480 A1
(43) Pub. Date: Mar. 12, 2026

(54) Utility Road Vehicle Comprising a Transport Refrigeration Machine

(71) Applicants: Andreas Schmitz, Münster (DE); Norbert Flacke, Gelsenkirchen (DE); Michael Rübig, Bühlertal (DE); Sebastian Wantia, Vreden (DE)

(72) Inventors: Andreas Schmitz, Münster (DE); Norbert Flacke, Gelsenkirchen (DE); Michael Rübig, Bühlertal (DE); Sebastian Wantia, Vreden (DE)

(73) Assignee: Schmitz Cargobull AG, Altenberge (DE)

(21) Appl. No.: 19/321,885

(22) Filed: Sep. 8, 2025

(30) Foreign Application Priority Data
Sep. 11, 2024 (EP) 24199822.8

(51) Int. Cl. B60P 3/20; B60H 1/00; B62D 53/06

(52) U.S. Cl. CPC B60P 3/20; B60H 1/00735; B60H 1/00878; B62D 53/06

(57) ABSTRACT

A utility road vehicle includes a transport refrigeration machine having at least one fan which is supplied by a 48 V auxiliary energy source in an auxiliary operating mode.

### CROSS-REFERENCE TO RELATED PATENT APPLICATION

This patent application claims the benefit of priority to European Patent Application No. 24199822.8 filed Sep. 11, 2024, the entire teachings and disclosures are incorporated herein by reference thereto.

### FIELD

The invention relates to a utility road vehicle comprising a transport refrigeration machine, in particular a transport refrigeration machine for temperature regulation, in particular cooling and/or heating, of a loading space of the utility road vehicle.

### BACKGROUND

Such a transport refrigeration machine may generate cooled air or heated air, for example, which is blown into the loading space of the utility road vehicle, in particular circulates in the loading space. For this purpose, the transport refrigeration machine may comprise at least one heating element and/or a heating circuit and/or cooling circuit. The cooling circuit may comprise a compressor that is driven by an electric motor and serves to compress a coolant, a condenser, a throttle device and a heat exchanger. In the cooling circuit, during cooling operation, the refrigerant compressed by the compressor flows via the condenser and a throttle device arranged downstream of the condenser in the flow direction, which throttle device may be embodied as a control valve, for example, to the heat exchanger. In the heat exchanger, the previously liquefied refrigerant is expanded and in the process draws heat from an air flow guided through the heat exchanger separately from the refrigerant, with the result that the air of the air flow is cooled. The cooled air of this air flow is subsequently blown (back) into the loading space of the utility road vehicle in order to cool said loading space.

It is often the case that the electric motor of such a transport refrigeration machine is supplied with electrical energy by the high-voltage energy source, such as for example a generator (which is driven for example in an internal combustion engine running at an optimum operating point). A high-voltage energy source may also be an energy store such as e.g. a high-voltage battery (for example including a DC voltage-to-AC voltage converter (DC/AC converter)). One advantage of a high-voltage energy source, in particular of a generator driven by way of an internal combustion engine, is, inter alia, that this source may provide high instantaneous powers such as are necessary for the operation of a transport refrigeration machine. One disadvantage, however, is that here a high-voltage energy source, in particular an internal combustion engine which drives the generator, may not provide arbitrarily low power and for example produces more power than is presently required by the transport refrigeration machine. Furthermore, under certain circumstances, an internal combustion engine may not provide arbitrarily high power, for example on account of exhaust gas limit values and/or maximally acceptable noise generation.

### SUMMARY OF SOME EXEMPLARY EMBODIMENTS OF THE INVENTION

It has been recognized that it is advantageous to enable the transport refrigeration machine to be supplied by means of at least one further energy source over and above the generator, in particular during driving operation of the utility road vehicle. A further energy source for example, in times of particularly high loading, could support a high-voltage energy source (for example operating close to its power limit) and/or, in times of low loading, could be used as an alternative to the high-voltage energy source (e.g. generator or high-voltage accumulator) for (e.g. temporarily) operating the transport refrigeration machine (in particular parts of the transport refrigeration machine) and/or for optimizing an operating point of the high-voltage energy source.

An energy store has been recognized as a first option of such a further energy source. An energy store may be embodied in particular as an electrochemical energy store such as a rechargeable accumulator. It has been recognized, inter alia, that an energy store may take up electrical energy and output it again in a time-staggered manner and, by virtue of this property, an operating point of the high-voltage energy source may be optimized and temporary support or temporary replacement of the high-voltage energy source is made possible.

Solar panels have been recognized as a further option of such a further energy source. In particular, it has been recognized that a high power consumption of the transport refrigeration machine may occur if the utility road vehicle is exposed to strong insolation. Moreover, it has been recognized that solar panels may be ecologically and economically attractive since solar energy present may be reliably converted into electrical energy using solar modules that have become cost-effective in the meantime.

Furthermore, it has also been recognized, however, that direct supply of components which are usually driven by the high-voltage energy source (in particular cooling components such as a compressor, typically operated with 400 V three-phase AC voltage) by means of an auxiliary energy source may necessitate cost-intensive component parts that are compatible with high voltage (e.g. DC-DC converters, switches and/or combinations thereof) and/or retransformations of the voltage, which may be uneconomic.

It is therefore an object of the present invention to design and develop a utility road vehicle comprising a transport refrigeration machine so as to open up cost-effective further energy sources for the transport refrigeration machine with the least possible outlay.

In accordance with a first exemplary aspect, a utility road vehicle is proposed, comprising:
a transport refrigeration machine comprising:
(i) at least one fan (e.g. evaporator fan, condenser fan and/or engine compartment fan), wherein the at least one fan is configured to be operated with electrical energy in a 48 V voltage band (e.g. via a DC/AC converter configured to convert 48 V DC into an AC voltage for the fan; for example, the DC/AC converter is part of the fan),
(ii) at least one temperature-influencing component (e.g. cold-generating, e.g. part of a refrigerant circuit, e.g. compressor, and/or heat-generating, e.g. heating rod), configured for regulating the temperature of a cargo space of the utility road vehicle, wherein the at least one temperature-influencing component is configured to be supplied with electrical energy in a high-voltage band,
(iii) a high-voltage energy source (e.g. 400 V AC; e.g. generator/HV accumulator), wherein the high-voltage energy source is configured to supply at least one of the (e.g. and at least in phases both of the) at least one temperature-influencing component of the transport refrigeration machine and the at least one fan with electrical energy (e.g. temporarily, e.g. in at least one operating mode of the transport refrigeration machine and/or of the utility road vehicle),
   a 48 V auxiliary energy source (e.g. solar module, e.g. comprising at least one or a plurality of voltage converters and/or an electrical energy store, e.g. accumulator), wherein the 48 V auxiliary energy source is configured to provide electrical energy having an (e.g. temporally variable) auxiliary power in the 48 V voltage band, wherein the 48 V auxiliary energy source is configured to supply at least one of the at least one fan (e.g. (only) the evaporator fan or the evaporator fan and at least one of the condenser fan or engine compartment fan) with electrical energy,
   wherein the utility road vehicle (and/or the transport refrigeration machine) is configured to keep the at least one temperature-influencing component free of an electrical energy supply by the 48 V auxiliary energy source (and/or from the 48 V voltage band) (e.g. unidirectional converter and/or other voltage band, and/or AC vs. DC),
   wherein the utility road vehicle is configured to supply at least one of the at least one fan with electrical energy at least partly (e.g. in addition to a supply originating from the high-voltage energy source) originating from the 48 V auxiliary energy source in an auxiliary operating mode (e.g. and/or to feed electrical power from the 48 V auxiliary energy source into the 48 V voltage band).

The disclosed utility road vehicle is for example a truck, a trailer or a semitrailer. Utility road vehicles are intended in particular for transporting goods, preferably piece goods, in public road transport. The utility road vehicle is in particular a utility road vehicle which is fitted with tires and which travels on gas-filled tires. For this purpose, the utility road vehicles have different types of utility vehicle bodies, which serve for receiving the goods to be transported in an interior space, in particular a loading space. In this regard, box bodies having fixed side walls and a fixed roof which enclose the interior space are known, for example. Since the box bodies are closed, box bodies are particularly suitable for the transport of temperature-sensitive goods, i.e. for example for so-called refrigerated transport. In order that the temperature of such temperature-sensitive goods does not exceed a limit value dependent on the goods during such refrigerated transport, the interior space (loading space) of the utility road vehicle is cooled.

Whenever the text here, hereinafter and/or hereinabove discloses that the utility road vehicle does something and/or is configured to do something, e.g. performs method steps, this is taken to mean in particular that a control apparatus associated with the utility road vehicle, e.g. a telematics unit and/or a control unit (e.g. of the utility road vehicle and/or of the transport refrigeration machine), controls and/or performs the corresponding steps.

The disclosed utility road vehicle furthermore comprises a transport refrigeration machine.

The transport refrigeration machine may be part of the utility road vehicle, e.g. may be mounted in and/or on a box body of the utility road vehicle.

The transport refrigeration machine is provided and/or designed and/or configured in particular for temperature regulation, i.e. cooling and/or heating, of an interior space, for example of the loading space, of the utility road vehicle. For this purpose, the transport refrigeration machine may comprise a cooling circuit comprising a compressor (e.g. compressor unit) for compressing a coolant, a condenser, a throttle device and a heat exchanger (evaporator). For example, the interior space, for example the loading space, of the utility road vehicle may be cooled by the transport refrigeration machine by virtue of the transport refrigeration machine drawing in air from the loading space, guiding it through the heat exchanger (evaporator) and extracting heat there and subsequently blowing (back) the air into the loading space of the utility road vehicle. Moreover, at least one heating element may be arranged (for example in the region of the heat exchanger). As a result, the transport refrigeration machine may also add heat to the air drawn in, i.e. heat up said air.

The transport refrigeration machine comprises at least one fan.

The fan may serve for example to transport air to and/or away from the heat exchanger. Moreover, the fan may serve to transport air from the interior space of the utility road vehicle to the transport refrigeration machine, in particular to the heat exchanger thereof. Moreover, the fan may serve for example to transport temperature-regulated air originating from the heat exchanger (e.g. back) into the interior space. The fan may thus cause a circulation of interior air in the interior space of the transport vehicle, in particular may make possible and/or foster a heat exchange between heat exchanger and air and thus convective heat transfer in the utility road vehicle. The fan may for example also be configured to cool at least one part of the transport refrigeration machine, for example a high-voltage energy source (e.g. motor with generator and/or high-voltage energy store) and/or compressor of the transport refrigeration machine.

According to the application, fans are not interpreted as temperature-influencing components. It should be noted, however, that fans may have an influence on the temperature of the interior space. In particular, a fan, by virtue of its power loss, may cause heating of the air in the interior space.

Hereinafter, a fan which draws in air from the interior space of the utility road vehicle and guides it into the interior space again via the evaporator is referred to as an evaporator fan. An evaporator fan may in particular ensure air recirculation in the interior space of the transport vehicle and/or, with an activated temperature-influencing component (e.g. heating facility and/or cooling circuit), enable the temperature of the interior air to be influenced by the respective temperature-influencing component. Furthermore, the evaporator fan may move air over at least one temperature sensor so that the latter may measure the air temperature. Thus, even with temperature-influencing components switched off, the operation of the evaporator fan is of relevance—e.g. for air recirculation in the interior space and for measuring the temperature of the air.

Furthermore, hereinafter a fan which feeds air to the condenser is referred to as a condenser fan. The condenser fan primarily transports heat away (e.g. as hot air; by convection) originating from the condenser into the surroundings thereof during cooling operation.

Moreover, a high-voltage energy source fan may furthermore be provided, which primarily performs air cooling of the high-voltage energy source (e.g. internal combustion engine with generator and/or high-voltage store) of the transport refrigeration machine.

By way of example, the transport refrigeration machine comprises at least one evaporator fan, at least one condenser fan and at least one high-voltage energy source fan.

By way of example, the at least one evaporator fan comprises one fan (e.g. single fan) or at least 2, 3, 4, 5 or more fans. By way of example, the at least one condenser fan comprises one fan (e.g. single fan) or at least 2, 3, 4, 5 or more fans. By way of example, the at least one high-voltage energy source fan comprises one fan (e.g. single fan) or at least 2, 3, 4, 5 or more fans.

Whenever properties of the at least one fan are disclosed, these properties are disclosed equally for all three types of fan (evaporator fan, condenser fan and high-voltage energy source fan).

At least one of the at least one fan or the at least one fan is configured to be operated in a 48 V voltage band. In other words, the fan is configured to be operated with a voltage lying in the 48 V voltage band. The fan is thus configured to receive electrical power in a 48 V voltage band and to convert the electrical power into a movement of air. For example, voltages with a deviation from 48 V of up to 10% (i.e. 43.2 V-52.8 V), 15% (i.e. 40.8 V-55.2 V) or 20% (i.e. 38.4 V-57.6 V) may still be understood as voltages of the 48 V voltage band. In accordance with one exemplary embodiment, the 48 V voltage band comprises voltages of at least 24 V and/or up to 60 V. By way of example, the voltages of the 48 V voltage band always have an absolute value lower than 60 V.

In the exemplary embodiments above, the absolute value of a voltage, for example of a voltage in a voltage band, may be determined for example as peak value, average value and/or root-mean-square value. “Always” here may mean for example that the respective ratio of the voltages to one another is present at every point in time.

The at least one fan is operated in particular with a DC voltage. The operation of the at least one fan in a 48 V voltage band, in particular with a DC voltage, makes it possible to achieve a particularly high energy efficiency of the fan and/or better controllability, in particular compared with operation with lower voltages, e.g. in a 12 V or 24 V voltage band or with an AC voltage. At the same time, a 48 V voltage band is safe for humans and may be realized with favorable components.

The at least one fan may comprise an inverter, for example, which obtains DC voltage in a 48 V voltage band and converts it into an AC voltage that is fed to the fan.

A respective fan may have for example a power consumption of up to 500 W, 1 kW, 1.5 kW or 2 kW. In particular, for example the at least one evaporator fan (e.g. aggregated over the at least one or a plurality of evaporator fans) may have a power consumption of at least or at most 500 W, 1 kW, 1.5 kW or 2 kW. By way of example, all fans of the transport refrigeration machine may have a total power (e.g. aggregated over the at least one or a plurality of evaporator fans) of at least or at most 1 kW, 1.5 kW, 2 kW, 3 kW, 4 kW, 5 kW, 6 kW or 7 kW. These power specifications may be for example average values, minimum values or maximum values during ongoing operation.

By way of example, at least one of the at least one fan, e.g. at least one of the evaporator fans or the evaporator fans, at least one of the condenser fans or the condenser fans and/or at least one of the high-voltage energy source fans or the high-voltage energy source fans, may be variable, in particular controllable, in terms of its power or alternatively may have an essentially constant power consumption, being e.g. uncontrollable.

The transport refrigeration machine furthermore comprises at least one temperature-influencing component.

A temperature-influencing component may comprise in particular a cold-generating component. By way of example, the cold-generating component may comprise a motor (e.g. an electric motor), a compressor (e.g. driven by the motor), a condenser, a throttle device, a heat exchanger and/or an evaporator. By way of example, a respective cold-generating component may thus comprise a cooling circuit and/or be part of a cooling circuit.

Furthermore, the temperature-influencing component may comprise a heat-generating component, e.g. an infrared emitter and/or a heating wire.

The type of temperature-influencing component (heat-generating or cold-generating) is determined according to its influence on a temperature of an interior space of the utility road vehicle. Even if a cold-generating component generates heat in an exterior region of the utility road vehicle, it is regarded as a cold-generating component as long as it is configured to cause cooling in the interior space.

The at least one temperature-influencing component is configured in particular to be supplied with electrical energy in a high-voltage band. A high-voltage band may comprise for example a voltage (e.g. AC voltage or DC voltage) of 260-540 V (e.g. root-mean-square value, e.g. 400 V three-phase AC voltage). In particular, the temperature-influencing component is configured to be operated with an AC voltage, for example a three-phase AC voltage. If the high-voltage energy source is a high-voltage accumulator, an inverter may be provided (e.g. comprised by the transport refrigeration machine), which is configured to convert a DC voltage of the high-voltage accumulator into an AC voltage for supplying the temperature-influencing component.

The transport refrigeration machine furthermore comprises a high-voltage energy source.

The high-voltage energy source is configured to supply the at least one temperature-influencing component of the transport refrigeration machine and/or the at least one fan with electrical energy.

By way of example, the high-voltage energy source, the transport refrigeration machine and/or the utility road vehicle may be configured, at a given point in time, from the high-voltage energy source, either (1) to supply both the at least one temperature-influencing component and the at least one fan with electrical energy, or (2) to supply the at least one temperature-influencing component with electrical energy, but not the at least one fan, or (3) to supply the at least one fan with electrical energy, but not the at least one temperature-influencing component.

The high-voltage energy source may comprise an electrical generator. The electrical generator is for example part of the utility road vehicle. The generator may be driven for example by an internal combustion engine, for example a diesel and/or gasoline engine. In one example, the energy source may be embodied as a diesel generator. The diesel generator may be part of the transport refrigeration machine.

The generator provides an AC voltage. The AC voltage provided by the generator is for example a single-phase AC voltage or a polyphase, in particular a three-phase AC voltage, in particular a 400 V three-phase AC voltage.

The electrical high-voltage energy source may for example alternatively or additionally comprise a high-voltage accumulator (also called high-voltage battery).

The high-voltage accumulator may be assigned to the transport refrigeration machine. By way of example, the high-voltage accumulator may be configured to supply (e.g. exclusively) the transport refrigeration machine with electrical energy. Moreover, the high-voltage accumulator may for example alternatively or additionally be assigned to the utility road vehicle (e.g. trailer) and supply at least one further component of the utility road vehicle (for example a telematics unit) with electrical energy. Moreover, the high-voltage accumulator may for example alternatively or additionally be configured to supply a drivetrain of the utility road vehicle with electrical energy. The high-voltage energy source is configured to supply at least parts of the transport refrigeration machine or the transport refrigeration machine with electrical energy.

The high-voltage accumulator may provide for example a DC voltage, for example a DC voltage of at least 100 V, 200 V, 300 V, 400 V, 500 V, 600 V, 800 V, 1000 V, 1.5 kV, 2 kV or more.

The high-voltage energy source may also comprise further components, for example a rectifier and/or components for compensating for voltage fluctuations such as a filter (e.g. comprising coils and/or capacitors and/or combinations thereof).

The high-voltage energy source may provide for example electrical DC voltage and/or single-phase or polyphase AC voltage. By way of example, the high-voltage energy source may be configured to provide a polyphase AC voltage, in particular three-phase AC voltage. In particular, a three-phase AC voltage with a voltage having a magnitude of 260 V to 540 V (e.g. 400 V) (root-mean-square value of the line-to-line voltages) may be provided by the electrical high-voltage energy source. Moreover, the high-voltage energy source may provide a DC voltage, for example a DC voltage of at least 100 V, 200 V, 300 V, 400 V, 500 V, 600 V, 800 V, 1000 V, 1.5 kV, 2 kV or more.

The transport refrigeration machine may comprise for example at least one component, in particular at least one temperature-influencing component, which is operated with three-phase AC voltage in a high-voltage band. In particular, a three-phase AC voltage with a voltage in the high-voltage band having a magnitude of 260 V to 540 V (e.g. 400 V) (root-mean-square value of the line-to-line voltages) may be necessary for this purpose. In particular, said component may be a temperature-influencing component, e.g. a motor, in particular an electric motor, of the transport refrigeration machine. The electric motor of the transport refrigeration machine may be a three-phase motor. One example of such a three-phase motor is a three-phase asynchronous motor or a three-phase synchronous motor. The electric motor may be for example a drive for a compressor and hence a temperature-influencing component.

Alternatively or additionally, the transport refrigeration machine may comprise for example at least one component which is operated with a DC voltage, in particular with a DC voltage in a 48 V voltage band. This may be for example at least one of the at least one fan of the transport refrigeration machine, in particular an evaporator fan, for example alternatively or additionally a high-voltage energy source fan or the high-voltage energy source fans and/or a condenser fan or the condenser fans.

The transport refrigeration machine may be configured to supply consumers both of the high-voltage band and of the 48 V voltage band with electrical power at least temporarily from the high-voltage energy source.

The high-voltage energy source is indirectly and/or directly electrically connected to the transport refrigeration machine. The energy source may be connected to the transport refrigeration machine in a direct connection for example via an electrical conductor such as for example a cable. In an indirect connection, at least one further component, for example a switch, a fuse, a measuring instrument and/or combinations thereof, may be arranged between the energy source and the transport refrigeration machine.

The high-voltage energy source may be individually connected to individual components of the transport refrigeration machine, for example a motor, compressor, evaporator, fan and/or combinations thereof. By way of example, the energy source may in this case directly supply individual components with the type of voltage that they require, in particular either with a three-phase AC voltage, in particular with a voltage having a magnitude of 260 V to 540 V (e.g. 400 V) (root-mean-square value of the line-to-line voltages). Moreover, a power supply unit, for example an AC/DC power supply unit, may be provided (for example as part of the transport refrigeration machine), which generates a DC voltage, in particular a DC voltage in a 48 V voltage band, from a high-voltage band of the high-voltage energy source.

Moreover, the energy source may be connected to a single terminal of the transport refrigeration machine, in particular in a single type of voltage, for example in a three-phase AC voltage. Originating from the terminal, one or more, in particular all, components of the transport refrigeration machine may be supplied with electrical energy at least temporarily. Optionally, the transport refrigeration machine is in this case configured to convert an internal conversion of the type of voltage at the terminal into at least one other type of voltage required by at least one component of the transport refrigeration machine.

By way of example, the transport refrigeration machine, the utility road vehicle, the energy source and/or the energy supply terminal may comprise a further voltage converter. By way of example, the transport refrigeration machine may comprise a 48 V power supply unit, which originating from the high-voltage band provides electrical power in a 48 V voltage band. By way of example, a voltage converter may be provided for this purpose, and is configured, originating from an AC voltage in the high-voltage band, in particular a three-phase AC voltage, in particular with a voltage having a magnitude of 260 V to 540 V (e.g. 400 V) (root-mean-square value of the line-to-line voltages), to convert that to a DC voltage, in particular a DC voltage in a 48 V voltage band. Moreover, a plurality of voltage converters may be provided, for example in order to convert from other voltages (DC or AC voltages) into a 48 V voltage band.

The further voltage converter may be connected for example to one of the three phases of the three-phase AC voltage terminal and/or between two phases. Moreover, the further voltage converter may be connected to all three phases, for example in a star or delta connection.

The further voltage converter (originating from high-voltage band to 48 V voltage band) may be designed for example for a power flow of at least or up to 100 W, 200 W, 300 W, 400 W, 500 W, 600 W, 700 W, 800 W, 900 W, 1 kW, 1.5 kW, 2 kW, 3 kW, 4 kW, 5 kW, 6 kW, or 7 kW.

The further voltage converter may be embodied in unidirectional fashion and permit only power flows originating from the high-voltage band into the 48 V voltage band.

Alternatively or additionally, the high-voltage energy source may be embodied as an energy supply terminal. The energy supply terminal may be configured to receive electrical energy for supplying the transport refrigeration machine from an external electrical energy supply.

The energy supply terminal may receive in particular electrical power in the form of DC voltage, AC voltage, in particular as a polyphase AC voltage, in particular in the high-voltage band. In particular, this may be a three-phase AC voltage, in particular a voltage having a magnitude of 260 V to 540 V (e.g. 400 V) (root-mean-square value of the line-to-line voltages). The energy supply terminal may be embodied in particular in the form of a socket outlet such as a three-phase socket outlet (e.g. CEE three-phase socket outlet).

Additionally or alternatively, the energy supply terminal may be fashioned as a charging terminal that is customary for the automotive sector, for example a charging socket and/or a charging plug. By way of example, this may be a Type 1 J1772, Type 2 Mennekes, CHAdeMo, CCS Combo Type 1, CCS Combo Type 2, GB/T or Supercharger charging plug or an associated charging socket. The utility road vehicle and/or the transport refrigeration machine may provide means by which the voltages provided by such a charging terminal are converted into types of voltage necessary for the transport refrigeration machine. For this purpose, in particular at least one voltage converter may be provided, in particular an inverter.

The transport refrigeration machine may thus be supplied with electrical energy originating from the energy supply terminal. For this purpose, the energy supply terminal receives electrical energy from an external electrical energy supply. The external electrical energy supply can be for example a charging infrastructure, in particular a charging point, an energy supply network, another vehicle, an energy store that is external to the utility road vehicle, and/or combinations thereof.

Furthermore, the utility road vehicle (in particular the transport refrigeration machine) comprises a 48 V auxiliary energy source.

The 48 V auxiliary energy source is configured to provide electrical energy at an auxiliary power in the 48 V voltage band. In particular, the 48 V auxiliary energy source is independent of the (e.g. of an instantaneous availability of the) high-voltage energy source. The 48 V auxiliary energy source should thus be separated from a 48 V power supply unit/voltage converter which, fed by the high-voltage energy source, provides a 48 V voltage. Instead, the 48 V auxiliary energy source is self-powered. However, this does not exclude a situation in which the 48 V auxiliary energy source has received electrical energy from the high-voltage energy source at a different (earlier) point in time.

In accordance with exemplary embodiments, the 48 V auxiliary energy source comprises a solar module, e.g. arranged on the (e.g. roof of the) utility road vehicle.

Alternatively or additionally, the 48 V auxiliary energy source comprises an electrical 48 V energy store, e.g. a 48 V accumulator. A 48 V energy store is configured in particular to provide electrical power without the aid of voltage converters in a 48 V voltage band. In particular, a 48 V energy store should be delimited from a 12 V energy store which may be for example a starter battery in an automobile. The latter energy store would require a DC converter in order to provide an electrical power in a 48 V voltage band. The 48 V energy store thus natively provides 48 V, for example by means of a corresponding cell voltage. The 48 V energy store may function in particular in a manner free of a step-up (e.g. boost) voltage converter.

The 48 V auxiliary energy source is configured to supply at least one of the at least one fan with electrical energy. In particular, the 48 V auxiliary energy source is configured to supply the evaporator fan with electrical energy. Alternatively, the 48 V auxiliary energy source is configured to supply the evaporator fan and at least one or both of the at least one condenser fan or of the at least one engine compartment fan with electrical energy or to supply all of the at least one fan with electrical energy.

In the event of an energy source (e.g. 48 V energy source or high-voltage energy source) being configured to supply a consumer (e.g. fan or temperature-influencing component) with electrical energy, this is taken to mean in particular that the respective energy source supplies and/or may supply the consumer with electrical energy in at least one operating mode. In particular, operating modes may also be provided in which a respective first energy source provides no energy for the respective consumer (e.g. while a respective other, second energy source provides electrical energy), even though the first energy source is configured in principle to supply the respective consumer with electrical energy.

The utility road vehicle and/or the transport refrigeration machine are/is furthermore configured to keep the at least one temperature-influencing component free of an electrical energy supply by the 48 V auxiliary energy source (and/or from the 48 V voltage band). By way of example, this may be ensured by a unidirectional 48 V voltage converter between the high-voltage band and the 48 V voltage band, which converter only permits power flows originating from the high-voltage band into the 48 V voltage band, but prevents power flows in the opposite direction.

The utility road vehicle and/or the transport refrigeration machine are/is configured to supply at least one of the at least one fan (e.g. the at least one evaporator fan) with electrical energy at least partly (e.g. completely or in addition to a supply originating from the high-voltage energy source) originating from the 48 V auxiliary energy source in an auxiliary operating mode. In the auxiliary operating mode, the 48 V auxiliary energy source thus feeds electrical power into the 48 V voltage band (into a 48 V subnetwork of the transport refrigeration machine).

In accordance with one exemplary embodiment of the first exemplary aspect, it is proposed that the auxiliary operating mode corresponds to a boost mode in which the at least one temperature-influencing component is supplied with electrical energy (e.g. with the auxiliary power) originating from the high-voltage energy source.

In the boost mode, therefore, simultaneously firstly at least one of the at least one fan is supplied with electrical energy originating from the auxiliary energy source and secondly the at least one temperature-influencing component is supplied with electrical energy originating from the high-voltage energy source.

It has been recognized that as a result of a supply of the at least one fan with auxiliary energy in the 48 V voltage band on the part of the high-voltage energy source (e.g. generator) in the high-voltage band resources become free for an increased energy feed to the at least one temperature-influencing component of the transport refrigeration machine.

As already explained above, the utility road vehicle, the transport refrigeration machine and/or the 48 V auxiliary source are/is configured to keep the at least one temperature-influencing component that obtains electrical energy in the high-voltage band free of an electrical energy supply by the 48 V auxiliary source, i.e. from the 48 V voltage band. This is taken to mean in particular that an (e.g. direct) energy flow originating from the 48 V auxiliary energy source to the temperature-influencing components is prevented. By way of example, a 48 V subnetwork to which the at least one fan and the 48 V auxiliary energy source are electrically connected may be separated, by a unidirectional converter, from a further subnetwork to which the temperature-influencing components (e.g. and the energy source) are connected (e.g. a 400 V three-phase AC subnetwork).

However, this does not exclude an indirect influencing of the electrical energy supply of the temperature-influencing components in the high-voltage band by the auxiliary power provided by the 48 V auxiliary energy source. In particular, at least one of the at least one temperature-influencing component may obtain more power from the high-voltage energy source if auxiliary power is provided by the 48 V auxiliary energy source, compared with the situation if no auxiliary power is provided by the 48 V auxiliary energy source.

As a particularly power-intensive temperature-influencing component which in the boost mode may take up more power than previously, in particular an electric motor of a compressor of a refrigeration circuit of the transport refrigeration machine is conceivable. Alternatively or additionally, a temperature-influencing component may comprise a heat-generating component, for example a heating component, for example a heating wire.

By way of example, in the boost mode the high-voltage energy source may provide electrical energy (e.g. for the temperature-influencing components) at least temporarily with at least 80%, 90%, 95%, 99% of a maximum power assigned to it. By way of example, furthermore, a large portion (e.g. at least 50%, 60%, 70%, 80%, 90%, 95%, 99%) of the fans and/or of the fan power of the fans of the transport refrigeration machine may be supplied and/or provided by the 48 V auxiliary energy source.

In the boost mode, temperature influencing of the loading space of the utility road vehicle is possible to a greater extent than in previous systems. This is achieved without a costly and in part regulatorily restricted change (increase in power) of the high-voltage energy source.

The boost mode may last for example for a time period of at least 5 min, 10 min, 20 min, 30 min, 40 min, 50 min, 1 h, 2 h. The 48 V auxiliary energy source may be configured for example to enable the boost mode over the respective time period.

In accordance with one exemplary embodiment of the first exemplary aspect, it is proposed that the auxiliary operating mode corresponds to a partial-load mode in which the at least one temperature-influencing component is (e.g. essentially or completely) deactivated (e.g. free of any energy supply and/or energy consumption) and/or the high-voltage energy source provides (e.g. essentially or completely) no power and/or the at least one temperature-influencing component is free of a supply with electrical energy originating from the high-voltage energy source.

The auxiliary operating mode may thus correspond to a partial-load mode and/or a boost mode.

In particular, an auxiliary operating mode in which temperature-influencing components (e.g. components to be supplied in the high-voltage band) are switched off is disclosed as a partial-load mode. It may be advantageous in this case to continue to operate at least one of the at least one fan, in particular one of the evaporator fans or the evaporator fans. By way of example, an air recirculation and thus a uniform temperature distribution in the interior space, in particular loading space, may be achieved as a result. Moreover, air may be caused to flow over a temperature sensor and the latter may thus continue to correctly detect the temperature of the interior space.

At least one of the fans, in particular at least one of the at least one evaporator fan and/or the at least one evaporator fan, is therefore supplied with electrical energy originating from the 48 V energy source in the partial-load mode. The high-voltage energy source may thus be deactivated in the partial-load mode. This may be especially advantageous in the case of a generator that may only operate with a minimum power. The minimum power may lie above the power consumption of the at least one fan, in particular of the at least one evaporator fan. Operation of the generator might thus be inefficient, which is avoided by the partial-load mode.

Moreover, in the partial-load mode, at least temporarily it is possible to operate, rather than the evaporator fan, other fans from among the at least one fan, for example (e.g. at least one of) the at least one high-voltage energy source fan and/or (e.g. at least one of) the at least one condenser fan.

In particular, in a partial-load mode, at least temporarily it is possible to operate (e.g. only) one of the at least one high-voltage energy source fan or (e.g. only) the at least one high-voltage energy source fan (e.g. engine compartment fan and/or high-voltage energy store fan). By way of example, the remaining fans of the transport refrigeration machine may be at rest. By way of example, the operation of the high-voltage energy source fan may ensure that at least one electronic component of the transport refrigeration machine, e.g. a component of power electronics and/or of a control device and/or an energy store, e.g. the high-voltage energy store, does not heat up beyond a permissible amount.

In the partial-load mode, a temperature of the loading space may be continuously monitored. By way of example, a temperature sensor may be used for this purpose, in particular a temperature sensor situated in a region of the transport refrigeration machine in which air is drawn to the evaporator originating from the loading space, and/or in a region of the transport refrigeration machine in which air is blown out to the loading space originating from the evaporator. The partial-load mode thus differs in particular from a pure overrun of fans.

The partial-load mode may last for example for a time period of at least 5 min, 10 min, 20 min, 30 min, 40 min, 50 min, 1 h, 2 h. The 48 V auxiliary energy source may be configured for example to enable the partial-load mode over the respective time period.

In accordance with one exemplary embodiment of the first exemplary aspect, it is proposed that
the at least one fan comprises at least one evaporator fan, at least one condenser fan and/or at least one high-voltage energy source fan (e.g. engine compartment fan), and wherein
in the partial-load mode the at least one of the at least one fan which is supplied with electrical energy originating from the 48 V auxiliary energy source comprises at least the evaporator fan, in particular wherein the condenser fan and/or the high-voltage energy source fan are/is free of supply with electrical energy originating from the 48 V auxiliary energy source, and/or
in the boost mode the at least one of the at least one fan which is supplied with electrical energy originating from the 48 V auxiliary energy source comprises at least the evaporator fan and at least one of condenser fan and/or the high-voltage energy source fan.

Whenever the text here, hereinafter and/or hereinabove mentions a supply of a component (e.g. of an electrical consumer) with electrical energy, this is taken to mean at least inter alia the provision of electrical power for operating the component. Conversely, the use of the term power, in particular the provision of power for operating a component (e.g. an electrical consumer), is taken to mean at least inter alia the transmission of energy, in particular the supply of the component with electrical energy.

In accordance with one exemplary embodiment of the first exemplary aspect, it is proposed that the transport refrigeration machine and/or the utility road vehicle and/or the 48 V auxiliary energy source are/is configured to control at least one temperature-influencing component depending on the auxiliary power, in particular in such a way that a power consumption of the at least one temperature-influencing component is increased as the auxiliary power rises.

The utility road vehicle, the transport refrigeration machine and/or the 48 V auxiliary energy source may be configured to determine the (e.g. instantaneous and/or retrievable, for example retrievable for a given time, e.g. at least 5 min, 10 min, 15 min, 20 min, 30 min, 40 min, 50 min, 1 h, 1.5 h, 2 h, 3 h or 4 h) auxiliary power. As a result, for example control of components such as e.g. a voltage converter between the high-voltage band and the 48 V voltage band and/or at least one temperature-influencing component depending on the auxiliary power may be made possible and/or fostered.

In particular, a cold-generating component, in particular an electric motor that drives the compressor, may be controlled (in this way) depending on the auxiliary power. Moreover, any other temperature-influencing component, in particular a heat-generating component, for example a heating component, may be controlled (in this way) depending on the solar power.

An increased power consumption may have the effect for example that temperature influencing of an interior space (e.g. loading space) of the utility road vehicle by the temperature-influencing component may turn out to be particularly pronounced. By way of example, a particularly rapid change in temperature may be caused and/or a particularly great deviation between an interior temperature and an exterior temperature. By way of example, a temperature-influencing (e.g. cold-generating) component may be controlled in a phase with high auxiliary power in such a way that temporary overinfluencing of the temperature of the interior space is attained. In the case of a cold-generating component, for example, the interior space may be temporarily set to a value below a usually (e.g. without auxiliary power) controlled minimum temperature value (e.g. minimum of a temperature corridor) (e.g. taking account of the requirements of a respectively transported good). As a result, a buffer (e.g. in the form of (extracted) heat) may be attained.

In particular, it has been recognized that in phases of high auxiliary power the loading on the high-voltage energy source that supplies both the temperature-influencing components and the fans may be relieved by partly solar-fed supply of the fans. The high-voltage energy source may thus utilize power capacities that have been liberated in comparison with a state without available auxiliary energy, by virtue of a higher power being provided for the temperature-influencing components. Exactly this possibility is substantively exploited when a (e.g. increase in the) power consumption of temperature-influencing components depending on the (e.g. in the case of high) auxiliary power is proposed.

In accordance with one exemplary embodiment of the first exemplary aspect, it is proposed that the transport refrigeration machine and/or the utility road vehicle and/or the solar module are/is furthermore configured to operate the at least one temperature-influencing component with a power which lies above an auxiliary energy source-independent maximum temperature-regulating power by a surplus power, wherein the surplus power is dependent on the auxiliary power, in particular rises as the auxiliary power rises, and/or at least essentially (e.g. to an extent of maximally 70%, 80%, 90%, 95%) corresponds to the auxiliary power (e.g. wherein the power always lies below a maximum power output of the energy source).

The auxiliary energy source-independent maximum temperature-regulating power may correspond for example to a maximally available power consumption of the temperature-influencing components if no auxiliary energy source is available. By way of example, the auxiliary energy source-independent maximum temperature-regulating power may be determined based on a maximum power output of the high-voltage energy source (e.g. 19 kW) minus a fan power (e.g. (maximum and/or average) power of all or a subset of the fans; e.g. 5 kW, thus for example an auxiliary energy source-independent maximum temperature-regulating power of 14 kW). By way of example, at least one further power consumption of at least one further component, e.g. a charging power of a battery, may furthermore be subtracted from the power of the high-voltage energy source in order to arrive at the auxiliary energy source-independent maximum temperature-regulating power.

It should be noted that an effective temperature-regulating power of the temperature-influencing components (e.g. for a given power consumption of the temperature-influencing components) may be dependent on an operating state of non-temperature-influencing components such as e.g. the at least one fan. By way of example, an effective cooling power may be reduced by a power loss of at least one of the at least one fan (e.g. of the at least one evaporator fan and/or of the at least one condenser fan). Consequently, by way of example, given a constant power consumption (e.g. with auxiliary energy source-independent maximum temperature-regulating power) of the temperature-influencing components, a variation of the effective temperature-regulating power may be caused by varying the power of at least one of the at least one fan, in particular evaporator fan and/or condenser fan.

The transport refrigeration machine comprises, see above, various consumers, inter alia the at least one temperature-influencing component (e.g. a refrigeration circuit, in particular comprising a compressor) and the at least one fan. In particular, the transport refrigeration machine may be configured in such a way that the energy source supplies the consumers of the transport refrigeration machine with electrical energy, i.e. feeds electrical power to the consumers. A power output of the energy source is limited to a maximum power (e.g. 19 kW). All of the consumers may jointly always take up for example only at most the maximum power of the energy source. An electrical power which is supplied to the at least one temperature-influencing component may thus correspond at most to the maximum power of the energy source minus the power demand of the at least one fan. This maximum power consumption of the at least one temperature-influencing component is referred to here in particular as auxiliary energy source-independent maximum temperature-regulating power.

The auxiliary energy source-independent maximum temperature-regulating power may assume for example a temporally variable value which is dependent e.g. on a temporally variable fan power. In particular, it has been recognized that the fan power of at least one of the at least one fan and/or of the at least one fan may be essentially constant, such that the auxiliary energy source-independent maximum temperature-regulating power is likewise essentially constant, at least temporarily.

It has been recognized that the limitation of the power consumption of the at least one temperature-influencing component to the auxiliary energy source-independent maximum temperature-regulating power may be overcome by the 48 V auxiliary energy source. In particular, the at least one temperature-influencing component may take up more power than the auxiliary energy source-independent maximum temperature-regulating power by a surplus power. By virtue of the fact that the at least one fan is at least partly fed by the auxiliary power, the at least one temperature-influencing component may take up in particular an additional surplus power which corresponds to the auxiliary power. According to the application, this does not necessitate an (e.g. direct) electrical power flow originating from the 48 V auxiliary energy source to the at least one temperature-influencing component, but rather merely a reduction of an electrical power flow originating from the energy source to the at least one fan.

In accordance with one exemplary embodiment of the first exemplary aspect, it is proposed that the utility road vehicle and/or the transport refrigeration machine and/or the 48 V auxiliary energy source are/is configured to operate the at least one fan originating from the high-voltage energy source with a power which lies below a (e.g. instantaneous) power consumption of the at least one fan by a deficit power, in particular wherein the absolute value of the deficit power corresponds to that of the surplus power and/or that of the auxiliary power.

By virtue of the reduction of a power flow originating from the energy source to the at least one fan, the energy source may pass on to the temperature-influencing components power capacities which have been liberated as a result and which are no longer required for the supply of the fans.

In accordance with one exemplary embodiment of the first exemplary aspect, it is proposed that the transport refrigeration machine and/or the utility road vehicle and/or the 48 V auxiliary energy source are/is furthermore configured to control the energy source depending on the auxiliary power, in particular in such a way that a power output of the energy source is reduced as the auxiliary power rises.

Moreover, by way of example, in addition or as an alternative to an increased (e.g. by a surplus power) power feed to at least one temperature-influencing component, the power output of the high-voltage energy source (e.g. in the boost mode) may be reduced. By way of example, a consumption of fuel (e.g. diesel of a diesel generator) may be saved as a result.

By way of example, in the boost mode, an auxiliary power may be set depending on an operating point of the high-voltage energy source, for example in such a way that the high-voltage energy source is operated at a favorable operating point.

In accordance with one exemplary embodiment of the first exemplary aspect, it is proposed that the at least one temperature-influencing component comprises at least one cold-generating component, in particular a component of a refrigerant circuit, in particular a compressor, and/or that the at least one temperature-influencing component comprises at least one heat-generating component, in particular at least one or more heating rods (e.g. heating wire).

Whenever the at least one temperature-influencing component is mentioned, this is taken to mean in particular a heat- and/or a cold-generating component. In particular, a cold-generating component is meant, in particular a component of a cooling circuit, in particular a compressor, in particular an electric motor configured to drive the compressor.

In accordance with one exemplary embodiment of the first exemplary aspect, it is proposed that the 48 V auxiliary energy source (and/or the transport refrigeration machine and/or the utility road vehicle) is configured to feed the auxiliary power completely (e.g. and/or at least to the extent of 50%, 60%, 70%, 80%, 90%, 95% or 99%) to the at least one fan which is supplied with electrical energy originating from the 48 V auxiliary energy source.

By way of example, the auxiliary power may be fed to the at least one fan at least temporarily or continuously, in particular completely. By way of example, a minimum proportion, e.g. at least 50%, 60%, 70%, 80%, 90%, 95% or 99%, of the auxiliary power may be conducted to the at least one fan, e.g. on average over time and/or at every point in time.

In accordance with one exemplary embodiment of the first exemplary aspect, it is proposed that the 48 V auxiliary energy source comprises at least one solar module.

The solar module may comprise in particular a voltage converter. By way of example, this may involve a DC voltage-to-DC voltage converter, also called DC/DC converter. By way of example, the converter comprises a low-capacity energy store for short-term storage of solar energy. The voltage converter may be configured for example to convert a solar-side voltage (e.g. temporally variably) into the 48 V voltage band. Furthermore, the voltage converter may be configured to optimize an operating point of the solar module, for example by maximum power point tracking (MPPT).

The solar module may output a solar power which may correspond for example to at least a portion or else the whole of the auxiliary power.

A solar module as (a part of the) 48 V auxiliary energy source may allow electrical energy to be obtained in particular when the utility road vehicle is exposed to high insolation. A solar-operated boost mode may thus be activated for example in phases of high cooling requirements. A solar-operated partial-load mode is also conceivable, in which at least one of the at least one fan, in particular the at least one evaporator fan, continues to run in a solar-operated manner while the temperature-influencing components and/or the high-voltage energy source are/is deactivated.

In accordance with one exemplary embodiment of the first exemplary aspect, it is proposed that the solar module comprises at least one solar panel, in particular wherein the at least one solar panel is arranged (e.g. secured) on a roof and/or on a side surface of the utility road vehicle.

The at least one solar panel may be configured to convert solar radiation into electrical current. By way of example, the solar panel is at least partly fashioned from a semiconductor, in particular silicon. The solar panel, depending on the solar radiation acting thereon, outputs electrical power, in particular with temporally variable voltage and/or with temporally variable current.

At least one of the at least one solar panel may be arranged for example on an exterior wall of the utility road vehicle, for example on a roof of the utility road vehicle.

The solar module may have for example a maximum power output which is less than or equal to a maximum power consumption of the at least one fan (fan power) (e.g. of the at least one compressor fan and/or of all fans of the transport refrigeration machine together). Moreover, the maximum power output of the solar module may be chosen to be higher than the (e.g. maximum) (e.g. compressor) fan power in order that a sufficient auxiliary energy supply is ensured even in suboptimal operating conditions (e.g. cloud cover, twilight). By way of example, the at least one fan may have a ventilation power consumption (e.g. 5 kW), while the solar module may maximally (e.g. under maximum insolation and/or optimum conditions, e.g. an optimum temperature and/or cleanness) provide a solar power (e.g. 3 kW) which is lower than the ventilation power consumption (e.g. 5 kW), or provide a solar power (e.g. 8 kW) which is higher than the ventilation power consumption (e.g. 5 kW). What may be achieved as a result is e.g. that the solar power may always be taken up by the at least one fan or else that the at least one fan may be supplied with power by the solar module as continuously as possible.

Besides the at least one solar panel, the solar module may comprise further components as well, in particular a control apparatus. The control apparatus may be part of a voltage converter. The control apparatus may be configured for example to perform continuous power maximization (maximum power point tracking, for short MPP tracking or MPPT). As a result, a power which is as high as possible may always be drawn from the at least one solar panel, which power is dependent inter alia on a voltage at the solar panel and/or a temperature of the solar panel.

The solar module may comprise for example at least one or more voltage converters (solar voltage converters). By way of example, at least one solar voltage converter may be configured to convert a solar-side voltage into 48 V DC voltage. As a result, the solar module may be incorporated in a 48 V network of the utility road vehicle and/or of the transport refrigeration machine.

The solar module and/or the transport refrigeration machine and/or the utility road vehicle are/is configured in particular to provide energy having a (e.g. temporally variable) solar power in the 48 V voltage band, in particular for the at least one fan.

In accordance with one exemplary embodiment, the solar module may manage (e.g. entirely) without solar voltage converters, in particular without 48 V DC voltage converters. The solar panels may be connected to the at least one fan electrically without converters, for example. By way of example, this may be taken to mean that the solar voltage is not converted to 48 V, but rather is passed directly to the fan. It has been recognized that the at least one fan may already comprise a respective voltage converter apparatus which accepts a variable input voltage. Moreover, it has been recognized that a possible overvoltage of the solar module (above 48 V) may be capped (e.g. by a fixed voltage controller).

According to the application, it has been recognized that precisely a 48 V DC voltage subnetwork of a transport refrigeration machine forms a well-suited infeed point for further energy sources such as in particular a solar module. This is especially relevant since the 48 V voltage band has been recognized as particularly favorable for fans as well. Finally, it has been recognized that a supply of the fans in the 48 V voltage band by the solar panel is particularly favorable since this makes possible the auxiliary operating mode, in particular the partial-load mode and/or the boost mode.

In accordance with one exemplary embodiment of the first exemplary aspect, it is proposed that the 48 V auxiliary energy source comprises at least one 48 V auxiliary energy store (e.g. not stepped up by DC/DC, but rather natively at 48 V; e.g. cell voltage and/or terminal voltage in the 48 V voltage band; e.g. without converters).

The auxiliary energy store may be configured to provide electrical energy. Additionally or alternatively, the auxiliary energy store may be configured to take up electrical energy. In other words, the auxiliary energy store may be rechargeable.

The auxiliary energy store may be formed as a battery and/or comprise a battery, for example. Here and hereinafter, a battery is understood to be in particular a secondary battery, in particular an accumulator, in particular an electrochemical accumulator. Whenever a battery is mentioned hereinafter, this therefore encompasses at least inter alia a rechargeable secondary battery and/or an accumulator which may both provide electrical energy and take up electrical energy. The batteries disclosed here may thus be both charged and discharged.

By way of example, the auxiliary energy store may be formed as a lead acid battery, a lithium ion battery, in particular a lithium iron phosphate (LFP) battery, a nickel cadmium or a nickel metal hydride battery, a sodium ion battery and/or combinations thereof.

The auxiliary energy store may comprise an energy storage module (e.g. in the form of a battery cell). In particular, the auxiliary energy store may also comprise two or more storage modules.

The auxiliary energy store is a 48 V auxiliary energy store which provides electrical energy in a 48 V voltage band. The 48 V auxiliary energy store is configured in particular to provide electrical energy in a 48 V voltage band without converters. A terminal voltage of the 48 V auxiliary energy store is thus in the 48 V voltage band. By way of example, an aggregated cell voltage, in particular by suitable serial and/or parallel interconnection of battery cells of the 48 V auxiliary energy store, may lie in the 48 V voltage band.

By way of example, the 48 V auxiliary energy store may be provided jointly with the solar module. These may for example jointly form the 48 V auxiliary energy source. By way of example, the 48 V auxiliary energy store may be charged by the solar module.

By way of example, the 48 V auxiliary energy store may have a capacity of at least 40 Ah, 50 Ah, 60 Ah, 70 Ah, 80 Ah, 90 Ah, 100 Ah, 150 Ah, 200 Ah, 250 Ah, 300 Ah, 350 Ah, 400 Ah, 450 Ah, 500 Ah or more and/or a stored energy of at least 2000 Wh, 3000 Wh, 4000 Wh, 5000 Wh, 6000 Wh, 7000 Wh, 8000 Wh, 9000 Wh, 10 kWh, 20 kWh, or 30 kWh. By way of example, the capacity of the 48 V auxiliary energy store may be chosen in such a way that when the 48 V auxiliary energy store has a full charge, said capacity is sufficient to supply the at least one evaporator fan or the entirety of the at least one fan of the transport refrigeration machine with electrical energy for at least 5 min, 10 min, 15 min, 20 min, 30 min, 45 min, 1 h, 2 h, 3 h, 4 h, 5 h, 6 h, 7 h, 8 h, 9 h, 10 h, 12 h, 16 h, 20 h or 24 h.

In accordance with one exemplary embodiment of the first exemplary aspect, it is proposed that the auxiliary power
corresponds to an instantaneous power of the solar module (e.g. solar power),
corresponds to an instantaneous discharge power of the auxiliary energy store,
corresponds to an instantaneous power of the solar module minus a charging power of the auxiliary energy store, and/or
corresponds to an instantaneous power of the solar module plus a discharge power of the auxiliary energy store.

In accordance with one exemplary embodiment of the first exemplary aspect, it is proposed that
the utility road vehicle is configured, in a charging mode, to feed a power originating from the high-voltage energy source into the 48 V voltage band, wherein the power lies above the power consumption of the at least one fan by a charging power in order to charge the auxiliary energy store with the charging power (e.g. if it is detected that the high-voltage energy source may achieve a higher efficiency by means of an increase in its power output (e.g. higher motor rotational speed); e.g. if a low state of charge of the auxiliary energy store is detected; e.g. if an imminent increased energy demand is predicted).

By way of example, the 48 V auxiliary energy store may be configured, in a charging mode, to receive electrical energy from the high-voltage energy source and to keep it available for example for a later use (e.g. a later auxiliary operating mode, in particular partial-load mode and/or boost mode).

By way of example, a situation may occur (e.g. in phases of low capacity utilization of the high-voltage energy source by the temperature-influencing components of the transport refrigeration machine and/or the fans) in which the high-voltage energy source is at an inefficient operating point and would achieve a higher efficiency if it could provide more electrical power. In this case, the 48 V auxiliary energy store may take up electrical power (charging power) and thus increase the efficiency of the high-voltage energy source and also keep the electrical energy available for later use.

By way of example, in the charging mode, the charging power may be set depending on an operating point of the high-voltage energy source, for example in such a way that the high-voltage energy source is operated at a favorable operating point (e.g. more favorable than without auxiliary energy source and/or auxiliary power). A favorable operating point is distinguished in particular by a high efficiency, e.g. by a high ratio between energy that is output (e.g. electrical energy in the high-voltage band) and (e.g. divided by) energy that is taken up (e.g. fuel). By way of example, an operating point may be determined based on predefined specifications concerning the high-voltage energy store, e.g. stored in a control device of the transport refrigeration machine and/or of the utility road vehicle.

In accordance with one exemplary embodiment of the first exemplary aspect, it is proposed that
the charging power is set based on a predicted energy demand (e.g. for imminent or present travel) of the transport refrigeration machine (e.g. based on weather, in particular temperature; based on route characteristics, for example shade and/or travel direction).

The utility road vehicle may be configured to predict an energy demand of the transport refrigeration machine for at least one route.

By way of example, the prediction may be based on a starting point (e.g. a present position of the utility road vehicle) and an end point (e.g. a destination of at least one good transported by means of the utility road vehicle). Furthermore, the prediction may include at least one intermediate stop, e.g. based on (e.g. legally prescribed) break times for at least one driver of the utility road vehicle and/or based on energy procurement needs (e.g. filling station stop and/or charging stop).

In particular, the prediction may be made for an imminent route section, e.g. at least or at most for the next 5 km, 10 km, 20 km, 50 km, 100 km, 150 km, 200 km, 300 km and/or at least 10 min, 20 min, 30 min, 1 h, 2 h, 3 h, 4 h of e.g. a route presently being traveled.

By way of example, based on the prediction, it is possible to determine whether and in what amount a solar power may be expected.

By way of example, by means of the prediction, it is possible to determine whether a boost mode will be necessary (e.g. because a stage with particularly high outside temperature is imminent). Moreover, based on the prediction, it is possible to determine whether a partial-load mode will be possible or necessary (e.g. because a section with low requirements in respect of cooling is imminent, e.g. a forest or tunnel section; e.g. because a stage with no possibility of operation of the high-voltage energy source is imminent, e.g. a ferry journey or a travel pause in a noise-sensitive region, e.g. a residential area, e.g. at night).

By way of example, based on the prediction, it is possible to determine whether a partial-load and/or a boost mode may be operated at least partly based on solar power, for example jointly with the 48 V auxiliary energy store.

By way of example, based on the prediction, it is possible to determine whether a charging mode is advantageous and/or favorable, for example at least partly based on a present state of charge and/or based on whether the latter is sufficient for an imminent retrieval of auxiliary power, for example in combination with a prediction of a retrievable solar power and/or a necessity of a boost and/or partial-load mode.

The prediction of the energy demand may be based for example on optimized route guidance. A route may be determined e.g. based on map material, e.g. according to Dijkstra's algorithm.

An energy demand prediction may be determined e.g. based on a length of a first route, an altitude profile, a temperature, a time of day, a climate zone, vegetation, building development and/or combinations thereof. For example, a temperature of a loading space (e.g. set temperature that has been set), a heat transfer coefficient of the loading space to the surroundings and an (e.g. averaged, e.g. predicted) outside temperature and/or insolation may be used to determine heat to be introduced and/or dissipated by a transport refrigeration machine for at least one first route to be traveled and thus an energy demand.

The predicted energy demand is based at least partly on at least one assumed driver behavior.

An assumed driver behavior relates in particular to how the utility road vehicle is operated by a driver. The driver may for example move the utility vehicle quickly or slowly, may actuate (e.g. open and/or close) doors to temperature-regulated loading spaces, may connect the utility road vehicle to an energy supply network and/or refuel it, may set a setpoint (e.g. setpoint temperature), may drive the vehicle along a predetermined route or may deviate therefrom, may make stops as predetermined or may choose different places for pausing and/or may omit stops and/or combinations thereof.

An assumed driver behavior may correspond for example to an optimum driver behavior (e.g. connection of the utility road vehicle to all charging possibilities, minimum door opening times, exact adherence to a predetermined route and/or departure times and/or break times, and/or combinations thereof). An assumed driver behavior may alternatively or additionally be an average driver behavior, e.g. an average over driver behaviors of a plurality of mutually different drivers, e.g. over (e.g. in each case) a plurality of, e.g. at least 2, 3, 4, 5, 10, 15, 20, 30, 40, 50, 100 or more journeys and/or routes.

It has been recognized that the driver behavior has a not insignificant influence on the energy demand of the transport refrigeration machine and it is therefore advantageous to include the driver behavior in the prediction of an energy demand.

In accordance with one exemplary embodiment of the first exemplary aspect, it is proposed that the energy demand is predicted based on a prediction of an energy consumption and a prediction of an energy generation.

It has been recognized that present-day transport refrigeration machines not only consume energy (i.e. expend it for regulating the temperature of an interior space, in particular loading space of the utility road vehicle). Instead, present-day transport refrigeration machines and/or utility road vehicles may also be operated in conjunction with energy generation devices, e.g. one or more solar modules and/or recuperation apparatuses (e.g. generator axles and/or regenerative brakes provided for this purpose). Moreover, transport refrigeration machines and/or utility road vehicles may be connected to an energy supply network (e.g. a charging station) and thereby take up energy. By way of example, the energy may be stored in an energy store of the transport refrigeration machine and/or of the utility road vehicle.

The predicted energy demand may thus be determined as a difference between energy consumption and energy generation. Alternatively, the energy demand may relate to (e.g. only) the energy consumption and/or the energy consumption minus energy generation from a solar module and/or a recuperation apparatus. An energy demand may thus indicate for example a necessity for draining and/or filling a store, e.g. a fuel store and/or an electrical energy store, during and/or before the at least one first route.

By way of example, as a result of driver behavior (e.g. travel on flat terrain, travel through sunny regions, parking in such a way that sunlight is incident on the solar module, connecting the utility road vehicle to a charging infrastructure, precooling a load of the utility road vehicle in network operation of the transport refrigeration machine, charging of an energy store (e.g. of the transport refrigeration machine and/or of the utility road vehicle) (e.g. before beginning a journey), rapidly closing doors to the temperature-regulated loading space, and/or combinations thereof), the energy demand for a given at least one first route may be lowered and/or may be increased in the case of contrary driver behavior. By way of example, this may take place as a result of increasing the energy generation and/or as a result of lowering the energy consumption.

In accordance with one exemplary embodiment of the first exemplary aspect, it is proposed that the energy demand, in particular the energy consumption, is predicted at least partly based on user data, wherein the user data comprise in particular at least one of the following:
route information concerning the at least one first route to be traveled, in particular information concerning a starting point and/or an end point, information concerning at least one coordinate profile of the at least one first route to be traveled (e.g. in the form of degree of longitude and/or latitude and/or altitude information, for example relief energy and/or meters in altitude of the route to be traversed),
at least one intermediate stop (e.g. with or without door opening, e.g. travel pause or unloading/loading stop on the at least one first route to be traveled,
at least one temperature setpoint, in particular a permissible deviation from the temperature setpoint,
at least one type and/or value of a good to be transported, and/or
at least one optimization target (e.g. pertaining to route planning and/or control of the transport refrigeration machine), in particular one of energy efficiency, CO2 saving, economic viability, operational time, temperature management, and/or component wear.

User data may be in particular data provided by a user, in particular a fleet manager and/or a planner of logistics operations, making use of the utility road vehicle according to the application. Moreover, user data may be provided by the driver, who may thus act as a user.

The user may make stipulations concerning the operation of the utility road vehicle and/or of the transport refrigeration machine. By way of example, the user may determine what route ought to be taken, what intermediate stops ought to be made and what temperatures ought to prevail in the loading space of the utility road vehicle (e.g. and with what tolerance).

Especially a change in the load of the road transport vehicle (e.g. loading and/or unloading) may have an influence on the energy demand of the transport refrigeration machine. By way of example, loading/unloading may necessitate opening the loading space of the utility road vehicle, whereby non-temperature-regulated air may penetrate into the loading space. Moreover, by way of example, an increased empty volume may arise, a subdivision of the utility road vehicle may be canceled or set up (e.g. if two or more goods whose temperatures are to be regulated differently have been or are being transported) and/or goods may be accommodated whose temperatures must firstly be regulated to a respective target temperature.

Furthermore, the manner of loading and/or unloading, in particular the duration thereof (e.g. of door opening) and/or an availability of an external energy source during the process, may influence an energy demand of the transport refrigeration machine.

User data may predetermine an optimization target relating for example to route planning and/or an operating mode of the utility road vehicle and/or of the transport refrigeration machine. By way of example, an optimization target of particularly accurate temperature management may lead to an increased energy consumption and hence energy demand, while an optimization target of energy efficiency causes the opposite. This may concomitantly influence the prediction of the energy demand.

An assumed driver behavior may be used to predict the energy demand, in particular the energy consumption. For example, a duration of a loading/unloading process, a door opening duration, precooling of goods to be transported, adherence to an envisaged route and/or combinations thereof may lead to a prediction of the energy demand, in particular of the energy consumption.

In accordance with one exemplary embodiment of the first exemplary aspect, it is proposed that the energy demand, in particular the energy consumption, is predicted at least partly based on telematics data, wherein the telematics data comprise in particular at least one of the following:
at least one actual temperature of at least one part of a loading space of the utility road vehicle (e.g. chamber),
at least one setpoint of at least one part of a loading space of the utility road vehicle (e.g. chamber),
at least one door status of the utility road vehicle,
at least one generator mode of the utility road vehicle,
at least one axle load of the utility road vehicle, and/or
at least one insulation quality of at least one loading space of the utility road vehicle (e.g. K value (incl. aging)).

Telematics data may be in particular data which are captured and/or provided (e.g. in an automated and/or sensor-based and/or model-based manner) by the utility road vehicle and/or the transport refrigeration machine. Alternatively or additionally, telematics data may relate to data received by the utility road vehicle and/or the transport refrigeration machine, e.g. by means of a telematics device, e.g. from a server.

In accordance with one exemplary embodiment of the first exemplary aspect, it is proposed that the energy demand, in particular the energy consumption, is predicted at least partly based on one of the following (e.g. online information, e.g. real-time data):
at least one weather datum, in particular at least one of temperature, air humidity, insolation and/or astronomical air mass, concerning the at least one first route to be traveled, and/or
at least one piece of traffic information, in particular at least one of (e.g. present) speed (e.g. owing to congestion) and/or at least one (e.g. present) stopping point on the at least one first route to be traveled (e.g. traffic lights, intersection and/or combinations thereof).

The data mentioned in this exemplary embodiment may be subsumed under the umbrella term online data and/or real-time data and relate to data which the utility road vehicle and/or the transport refrigeration machine may acquire from information sources which provide present pieces of information, in particular relating to the at least one first route. By way of example, the online data may originate from third parties (neither fleet operators nor vehicle providers), e.g. from at least one weather service and/or at least one map service provider.

By way of example, for the prediction of the energy demand it may be known that a particularly high temperature will result in a high energy consumption of the transport refrigeration machine. By way of example, a stage with particularly high requirements (e.g. as a result of a section having little overgrowth and/or no shading) on a particularly hot and/or sunny day may be determined as particularly causal of an increase in energy demand.

In addition, it may be known that high insolation will result in high energy generation by the solar module. By way of example, it may be known on the other hand that congestion in a tunnel, a town/city center and/or a forested area with little insolation counteracts energy generation by a solar module.

Online data may be implemented for example via a communication connection to at least one, e.g. stationary, device that is different than the utility road vehicle, for example a server, for example over the Internet. The utility road vehicle and/or the transport refrigeration machine may comprise communication means suitable for this purpose.

In accordance with one exemplary embodiment of the first exemplary aspect, it is proposed that the energy demand, in particular the energy generation, is predicted based on at least one of the following:
at least one state of charge of an energy store, in particular of a high-voltage energy store, of the utility road vehicle,
at least one temperature of an energy store, in particular of a high-voltage energy store, of the utility road vehicle,
a recuperation energy prediction, in particular wherein the recuperation energy prediction is determined based on topography and/or traffic information concerning the at least one first route to be traveled,
a solar energy prediction, in particular wherein the solar energy prediction is determined based on weather and/or topography information (e.g. shading of a route) concerning the at least one first route to be traveled,
a charging energy prediction, in particular wherein the charging energy prediction is determined based on an (e.g. (real-time) availability of an) infrastructure and/or standing time during the at least one first route to be traveled, and/or
at least one electricity price (e.g. while traveling along the at least one first route to be traveled).

For determining the energy demand, in particular the energy generation, internal and/or external energy sources and/or energy stores may be considered, for example.

A state of charge (SOC) of an energy store may for example be informative of how much energy may be obtained from the energy store and/or how much (e.g. additional) energy may be temporarily stored. In the case of a high state of charge of the energy store, by way of example, a predicted energy demand may be fixed lower than in the case of a drained energy store. A state of charge may be dependent for example on a driver behavior, e.g. (omission of) charging of an energy store (e.g. before the beginning of travel).

A recuperation energy prediction may indicate for example how much energy may be obtained by recuperation, e.g. during travel along at least one of the at least one first route. By way of example, the utility road vehicle may allow recuperation of braking energy. By way of example, an increased recuperation energy may thus be expected on routes having many changes of speed (e.g. town/city traffic or else phases of relatively long braking maneuvers such as sloping routes) compared with routes of constant speed (e.g. interstate highway). A recuperation energy prediction may be predicted based on an assumed driver behavior, for example on adherence to a route (e.g. town/city or mountains) or on an assumed uniformity of speed.

A solar energy prediction may indicate for example an electrical energy which may be generated by means of one or more solar modules, e.g. during travel along at least one of the at least one first route. The solar energy prediction may be dependent on present weather conditions (e.g. known from online data), for example cloudiness or sunniness. The solar energy prediction may be dependent on shading of at least one of the at least one first route, for example by a forest, buildings or mountains. The solar energy prediction may be associated for example with a state of charge of at least one energy store. By way of example, a solar energy prediction may turn out to be higher if the energy store is more drained, since in that case electrical solar energy does not have to be used immediately (for operating the transport refrigeration machine), but rather remains flexibly usable for later use. By way of example, the solar energy prediction may be based on an assumed driver behavior. For example, this may be parking the utility road vehicle (e.g. during a travel pause) in a sunny region such that the solar module produces electrical energy. Moreover, this may be adhering to a predetermined route (through e.g. non-shaded regions).

Moreover, a charging energy prediction may be used for a prediction of an energy demand. By way of example, the charging energy prediction may be based on an availability of an energy supply infrastructure such as e.g. a charging infrastructure, an overhead line, an inductive roadway and/or combinations thereof. By way of example, a charging energy prediction may be based on an assumed driver behavior, e.g. connecting the utility road vehicle or the transport refrigeration machine to an energy source, extending a current collector and/or traveling on an inductive roadway.

An electricity price may be used e.g. to establish whether or not it is economically viable to charge a utility road vehicle in a given time and/or at a given location. By way of example, the electricity price in one state may be particularly high (e.g. in the morning), and so charging is not economically viable in this state during this time. Accordingly, energy generation (e.g. during the at least one first route) may be predicted to be lower, and an energy demand to be higher.

In accordance with one exemplary embodiment of the first exemplary aspect, it is proposed that the assumed driver behavior comprises at least one of the following:
connection of the utility road vehicle to an energy supply infrastructure (e.g. during a travel pause, choice of a type of connection, duration of connection, frequency/number of connections, carrying out retarded connection, e.g. if charging point is occupied at the beginning of a travel pause and becomes free),
door opening behavior of at least one door to a (e.g. temperature-regulated) loading space of the utility road vehicle, in particular duration and/or frequency of door openings,
adherence to a predetermined route (e.g. through shady and/or flat areas, around towns/cities, stops at places which offer a charging infrastructure),
adherence to an envisaged stop (e.g. where a charging infrastructure is available),
adherence to an envisaged departure time (e.g. time of day),
precooling (e.g. before the beginning of travel, e.g. by means of energy from a network terminal, CEE energy) of a goods load of the utility road vehicle, and/or
precharging of at least one energy store.

A driver behavior may comprise e.g. connection of the utility road vehicle and/or the transport refrigeration machine to an energy supply infrastructure. For example, the connection may be performed during a travel pause. By way of example, a specific type of connection may be chosen, e.g. a regular 230 V 50 Hz CEE socket outlet in Germany, a three-phase heavy-current terminal or a charging station for electric vehicles. By way of example, a charging station may be embodied as a Type 1 J1772, Type 2 Mennekes, CHAdeMo, CCS Combo Type 1, CCS Combo Type 2, GB/T or Supercharger charging plug. Furthermore, the driver behavior may relate to a duration of connection (e.g. at least 5 min, 15 min, 30 min, 1 h, 2 h, 3 h), a frequency (e.g. relative to a number of travel pauses and/or during travel along one of the at least one first route).

A driver behavior may relate e.g. to carrying out retarded connection to an energy supply infrastructure. By way of example, a terminal (e.g. charging point) may be occupied, e.g. at the beginning of a travel pause. A driver may thereupon seek a parking place without any charging possibility and may not procure any energy for the entire duration of the travel pause. Alternatively, the driver may (e.g. or may not) begin a charging process when the terminal becomes free.

By way of example, a driver behavior may be determined based on a respective possibility of carrying out the driver behavior. For example, omission of connection to an energy supply infrastructure may be assessed as omission only if it is known that connection is possible, and not if it is known that connection is impossible (e.g. because corresponding connection possibilities are occupied).

A driver behavior may relate e.g. to a door opening behavior of at least one door to a loading space of the utility road vehicle. For example, this may relate to a duration and/or frequency of door openings, for example during and/or independently of loading and/or unloading processes.

A driver behavior may relate e.g. to adherence to a predetermined route. The route may have been determined for example in such a way that this route is favorable for e.g. an energy generation method (e.g. solar and/or recuperation and/or for charging at energy supply infrastructure devices). Adherence may make possible the envisaged energy generation, and any deviation may prevent this.

A driver behavior may relate e.g. to adherence to a predetermined departure time. By way of example, a departure time may be particularly favorable for an energy balance of the transport refrigeration machine, e.g. because sunlight may be used for solar energy generation and/or because delays resulting from congestion are avoided. Non-adherence to the departure time may accordingly lead to an increase in the energy demand.

By way of example, a driver behavior may also relate to adherence to an envisaged stop (e.g. a position of a respective stop (e.g. rest stop, filling station); and/or e.g. a duration of a respective stop) (e.g. for a travel pause). By way of example, a route may be determined in such a way that a travel pause is carried out at a stopping position at which a charging infrastructure is located. Selection of this stopping position by the driver may be assumed, for example in at least a fraction of the travel pauses of the at least one first route, e.g. for 30%, 50%, 70%, 80%, 90% or 95% of the travel pauses.

Furthermore, a driver behavior may relate to precooling of a goods load of the utility road vehicle, e.g. before the beginning of travel along the at least one first route and/or by means of energy from an energy supply infrastructure, in particular from a network terminal, CEE, and/or a charging station.

Furthermore, a driver behavior may relate to precharging of at least one energy store, e.g. before the beginning of travel along the at least one first route and/or by means of energy from an energy supply infrastructure, in particular from a network terminal, CEE, and/or a charging station.

In accordance with one exemplary embodiment of the first exemplary aspect, it is proposed that the high-voltage energy source is a generator, in particular a generator operated with a fuel, in particular a fossil fuel, in particular a diesel generator, and/or wherein the high-voltage energy source is a high-voltage accumulator and/or wherein the high-voltage energy source comprises an energy supply terminal, in particular a charging socket, in particular for a charging infrastructure, and/or a three-phase socket outlet.

In accordance with one exemplary embodiment of the first exemplary aspect, it is proposed that the utility road vehicle comprises at least one trailer for utility road vehicles or is such a trailer.

In accordance with a second exemplary aspect, a method for operating a utility road vehicle, in particular according to the first aspect, is proposed, wherein the utility road vehicle comprises a transport refrigeration machine with at least one fan (e.g. an evaporator fan, condenser fan and/or engine compartment fan), wherein the at least one fan is configured to be operated with electrical energy in a 48 V voltage band (e.g. via a DC/AC converter configured to convert 48 V DC into an AC voltage for the fan; e.g. the DC/AC converter is part of the fan), with at least one temperature-influencing component (e.g. cold-generating, e.g. part of a refrigerant circuit, e.g. compressor, and/or heat-generating, e.g. heating rod), configured for regulating a temperature of a cargo space of the utility road vehicle, wherein the at least one temperature-influencing component is configured to be supplied with electrical energy in a high-voltage band, and with a high-voltage energy source (e.g. 400 V AC; e.g. generator/HV accumulator), wherein the high-voltage energy source is configured to supply at least one of the (e.g. and at least in phases both of the) at least one temperature-influencing component of the transport refrigeration machine and the at least one fan with electrical energy, wherein the utility road vehicle furthermore comprises a 48 V auxiliary energy source (e.g. solar module, e.g. comprising at least one or more voltage converters and/or an electrical energy store, e.g. accumulator), wherein the 48 V auxiliary energy source is configured to provide electrical energy having an (e.g. temporally variable) auxiliary power in the 48 V voltage band, wherein the 48 V auxiliary energy source is configured to supply at least one of the at least one fan (e.g. (only) the evaporator fan or the evaporator fan and at least one of the condenser fans or engine compartment fans) with electrical energy, wherein the method comprises
keeping the at least one temperature-influencing component free of an electrical energy supply by the 48 V auxiliary energy source (and/or from the 48 V voltage band) (e.g. unidirectional converter and/or other voltage band, and/or AC vs. DC),
supplying, in an auxiliary operating mode, at least partly, at least one of the at least one fan with electrical energy (e.g. in addition to a supply originating from the high-voltage energy source) originating from the 48 V auxiliary energy source (e.g. and/or to feed electrical power from the 48 V auxiliary energy source into the 48 V voltage band).

In accordance with one exemplary embodiment of the second exemplary aspect, it is proposed that the auxiliary operating mode corresponds to a boost mode in which the at least one temperature-influencing component is supplied with electrical energy (e.g. only) originating from the high-voltage energy source (e.g. wherein the high-voltage energy source runs with its maximum power).

In accordance with one exemplary embodiment of the second exemplary aspect, it is proposed that the auxiliary operating mode corresponds to a partial-load mode in which the at least one temperature-influencing component is (e.g. essentially or completely) deactivated (e.g. free of any energy supply and/or energy consumption) and/or the high-voltage energy source provides (e.g. essentially or completely) no power (and/or the at least one temperature-influencing component is free of a supply with electrical energy originating from the high-voltage energy source).

In accordance with one exemplary embodiment of the second exemplary aspect, it is proposed that
the at least one fan comprises at least one evaporator fan, at least one condenser fan and/or at least one high-voltage energy source fan (e.g. engine compartment fan), and wherein
in the partial-load mode the at least one of the at least one fan which is supplied with electrical energy originating from the 48 V auxiliary energy source comprises at least the evaporator fan, in particular wherein the condenser fan and/or the high-voltage energy source fan are/is free of supply with electrical energy originating from the 48 V auxiliary energy source, and/or
in the boost mode the at least one of the at least one fan which is supplied with electrical energy originating from the 48 V auxiliary energy source comprises at least the evaporator fan and at least one of condenser fan and/or the high-voltage energy source fan.

In accordance with one exemplary embodiment of the second exemplary aspect, it is proposed to control at least one temperature-influencing component depending on the auxiliary power, in particular in such a way that a power consumption of the at least one temperature-influencing component is increased as the auxiliary power rises.

In accordance with one exemplary embodiment of the second exemplary aspect, it is proposed to operate the at least one temperature-influencing component at least temporarily with a power which lies above an auxiliary energy source-independent maximum temperature-regulating power of the high-voltage energy source by a surplus power (e.g. maximum power output of the energy source (e.g. 19 kW) minus fan power (e.g. 5 kW), e.g. 14 kW, by way of example furthermore minus a power consumption of further components such as e.g. a charging power of a (e.g. 12 V) battery), wherein the surplus power is dependent on the auxiliary power, in particular rises as the auxiliary power rises, and/or at least essentially (e.g. to an extent of maximally 70%, 80%, 90%, 95%) corresponds to the auxiliary power (e.g. wherein the power always lies below a maximum power output of the energy source).

In accordance with one exemplary embodiment of the second exemplary aspect, it is proposed to supply at least one fan originating from the high-voltage energy source (e.g. in the auxiliary mode, in particular in the boost mode) with a power which lies below a (e.g. instantaneous) power consumption of the at least one fan by a deficit power, in particular wherein the absolute value of the deficit power corresponds to that of the surplus power and/or that of the auxiliary power.

In accordance with one exemplary embodiment of the second exemplary aspect, it is proposed to control the high-voltage energy source depending on the auxiliary power, in particular in such a way that a power output of the high-voltage energy source is reduced as the auxiliary power rises.

In accordance with one exemplary embodiment of the second exemplary aspect, it is proposed to feed the auxiliary power completely (e.g. and/or at least to the extent of 50%, 60%, 70%, 80%, 90%, 95% or 99%) to the at least one of the at least one fan which is supplied with electrical energy originating from the 48 V auxiliary energy source.

In accordance with one exemplary embodiment of the second exemplary aspect, it is proposed that the auxiliary power
corresponds to an instantaneous power of the solar module,
corresponds to an instantaneous discharge power of the auxiliary energy store,
corresponds to an instantaneous power of the solar module minus a charging power of the auxiliary energy store, and/or
corresponds to an instantaneous power of the solar module plus a discharge power of the auxiliary energy store.

In accordance with one exemplary embodiment of the second exemplary aspect, it is proposed, in a charging mode, to feed a power originating from the high-voltage energy source into the 48 V voltage band, wherein the power lies above the power consumption of the at least one fan by a charging power in order to charge the auxiliary energy store with the charging power (e.g. if it is detected that the high-voltage energy source may achieve a higher efficiency by means of an increase in its power output (e.g. higher motor rotational speed); e.g. if a low state of charge of the auxiliary energy store is detected; e.g. if an imminent increased energy demand is predicted).

In accordance with one exemplary embodiment of the second exemplary aspect, it is proposed
the charging power is set based on a predicted energy demand (e.g. for imminent or present travel) of the transport refrigeration machine (e.g. based on weather, in particular temperature; based on route characteristics, for example shade and/or travel direction).

In accordance with a third exemplary aspect, an apparatus (e.g. controller of the transport refrigeration machine and/or telematics unit, CTU; e.g. part of the transport refrigeration machine and/or part of the utility road vehicle) is proposed, comprising means configured for controlling and/or performing a method according to the second exemplary aspect (for example wherein the means comprise at least one processor and a memory, wherein the memory comprises instructions which, when they are executed by the processor, have the effect that the apparatus performs the method, and/or further means such as for example at least one communication means by which the controller may communicate for example with at least one further component, for example with the transport refrigeration machine, e.g. a controller of the transport refrigeration machine, and/or with the energy source, the at least one temperature-influencing component, the at least one fan, and/or with the solar module).

Further advantageous exemplary configurations of the invention may be gathered from the following detailed description of some exemplary embodiments of the present invention, in particular in conjunction with the figures. However, the figures accompanying the application are intended to be used only for the purpose of illustration but not for the purpose of determining the scope of protection of the invention. The accompanying drawings are not necessarily true to scale and are intended to only reflect the general concept of the present invention by way of example. In particular, features included in the figures are however in no way intended to be considered a necessary part of the present invention.

### BRIEF DESCRIPTION OF THE DRAWINGS

In the figures:

FIG. 1 shows a schematic illustration of one exemplary embodiment of a utility road vehicle according to the invention;

FIG. 2 shows a schematic illustration of one exemplary embodiment of a utility road vehicle comprising a transport refrigeration machine according to the invention;

FIG. 3 shows a schematic illustration of one exemplary embodiment of a utility road vehicle comprising a transport refrigeration machine according to the invention;

FIGS. 4a and 4b show a schematic illustration of one exemplary embodiment of an operating mode of a transport refrigeration machine according to the invention;

FIG. 5 shows a schematic illustration of one exemplary embodiment of an operating mode of a transport refrigeration machine according to the invention.

### DETAILED DESCRIPTION OF SOME EXEMPLARY EMBODIMENTS

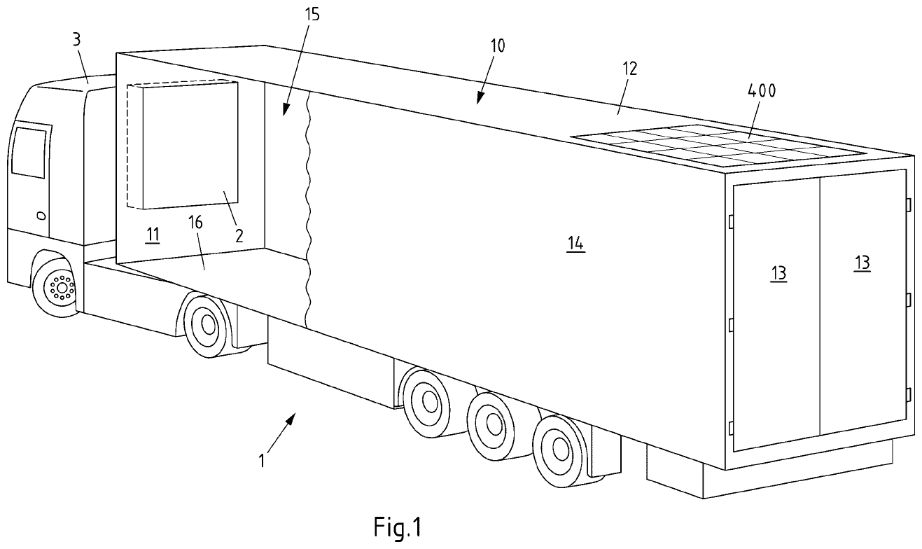

FIG. 1 is a schematic illustration of one exemplary embodiment of a vehicle 1 according to the invention, for example according to the first aspect of the invention.

The vehicle 1 shown is a utility vehicle 1, more precisely a trailer 1, even more precisely a semitrailer 1, having a box body 10. The box body 10 comprises a fixed front wall 11, a fixed roof 12, a rear wall formed by wing doors 13, and fixed side walls 14. In this case, the box body 10 encloses a loading space 15 for receiving goods to be transported.

An apparatus 200 in accordance with the third aspect of the invention is arranged in the vehicle 1, the approximate position of said apparatus being indicated by dashed lines. This may involve for example a telematics unit 200 of the trailer 1.

The transport refrigeration machine 2 serves for cooling and/or heating the loading space 15, such that temperature-sensitive goods may be transported in the loading space 15. For this purpose, the transport refrigeration machine 2 may for example cool and/or heat air and subsequently blow it into the loading space 15.

At least one solar module and/or a solar panel 400 may be arranged on the roof 12.

The semitrailer 1 is towed by a tractor unit 3.

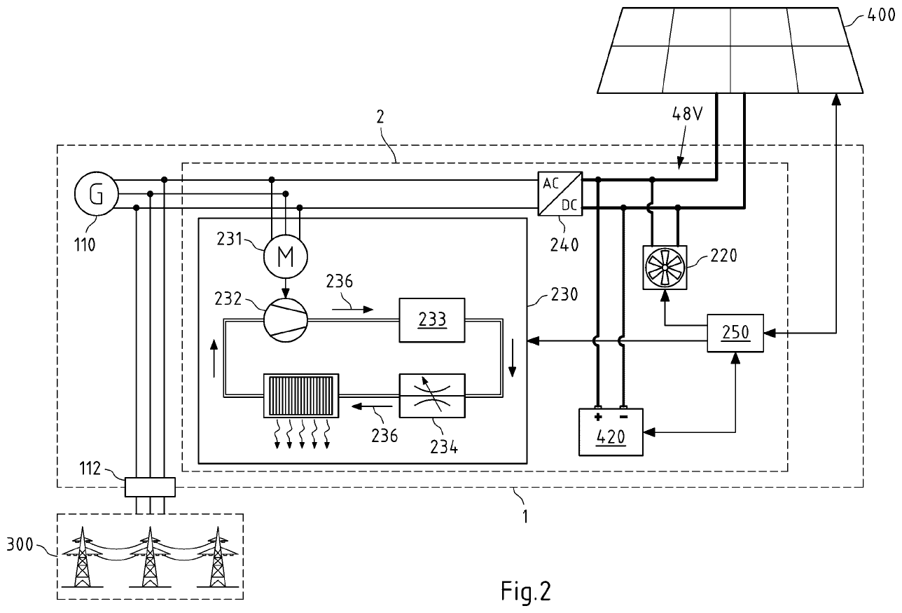

FIG. 2 shows a schematic circuit diagram of a utility road vehicle 1 in accordance with one exemplary embodiment according to the invention as shown in FIG. 1.

A transport refrigeration machine 2 is discernible. This is connected to a high-voltage energy source 110. In the embodiment shown, the high-voltage energy source 110 is embodied as a generator 110. Alternatively, the high-voltage energy source 110 may be embodied as a high-voltage energy store.

The generator 110 may be driven for example by a motor, in particular by a motor integrated in the transport refrigeration machine 2, for example by an internal combustion engine, in particular a diesel engine.

The high-voltage energy source 110, in particular the generator 110, is configured in particular to provide electrical energy in the form of an AC voltage (e.g. a three-phase AC voltage with a voltage having a magnitude of 260 V to 540 V (e.g. 400 V) (root-mean-square value of the line-to-line voltages)).

The high-voltage energy source 110 may also be embodied as an energy supply terminal 112. The energy supply terminal 112 is configured in particular to connect the utility road vehicle 1 to an external energy supply 300. The external energy supply 300 may comprise in particular an energy supply network. The external energy supply 300 may likewise comprise a charging infrastructure. The energy supply terminal 112 may be provided for example in the form of a socket outlet, such as for example a three-phase socket outlet (e.g. CEE). Moreover, the energy supply terminal 112 may assume the form of a charging terminal, in particular a charging plug and/or a charging socket, in particular a charging terminal that is customary in the automotive sector.

The transport refrigeration machine 2 is electrically connected to the high-voltage energy source 110. In particular, this connection may be embodied in three-phase fashion, for transmitting a three-phase AC voltage. The respective connections may be embodied directly, for example. Moreover, indirect connections may be provided, for example via a respective relay.

The transport refrigeration machine 2 comprises at least one temperature-influencing component 230, in particular a cooling circuit 230. Moreover, a heating element (not shown) may be provided as a temperature-influencing component. The cooling circuit 230 comprises a motor 231, in particular an electric motor, a compressor 232, a condenser 233, a throttle valve 234 and a heat exchanger 235. The refrigerant 236 circulates in the cooling circuit 230.

The cold-generating component 230 furthermore comprises a cooling circuit. In the heat exchanger 235, the previously liquefied refrigerant 236 is expanded and in the process draws heat from an air flow guided through the heat exchanger 235 separately from the refrigerant, with the result that the air of the air flow is cooled. The cooled air of this air flow is subsequently blown for example into the loading space 15 of the semitrailer 1 in order to cool this.

The motor 231 may be operated via a three-phase terminal. In particular, the cooling circuit 230 may be operated with a three-phase AC voltage (e.g. a three-phase AC voltage with a voltage in a high-voltage band, in particular having a magnitude of 260 V to 540 V (e.g. 400 V) (root-mean-square value of the line-to-line voltages)). The motor 231 may be part of the cold-generating component 230.

The transport refrigeration machine 2 furthermore comprises at least one fan 220. The fan 220 is configured to be supplied with electrical energy in a 48 V voltage band, in particular with a DC voltage. The transport refrigeration machine 2 may comprise in particular a plurality of fans with different functions, for example. In particular, the transport refrigeration machine may comprise at least one evaporator fan 220, one condenser fan 220 and one high-voltage energy source fan 220.

The transport refrigeration machine comprises a voltage converter 240. The voltage converter 240 is configured in particular to convert an AC voltage, in particular a three-phase AC voltage, in particular with a voltage having a magnitude of 260 V to 540 V (e.g. 400 V) (root-mean-square value of the line-to-line voltages), into a DC voltage, in particular in a 48 V voltage band. In this way, the voltage converter 240 may enable the at least one fan 220 to be supplied from the high-voltage energy source 110. The voltage converter 240 is unidirectional, in particular, and allows only a power flow originating from the AC voltage (or the high-voltage band) to the DC voltage (or the 48 V voltage band).

The utility road vehicle 1 may furthermore comprise a 48 V auxiliary energy store 420 as a first example of a 48 V auxiliary energy source. The 48 V auxiliary energy store 420 is a battery, in particular. The 48 V auxiliary energy store 420 is configured in particular to be operated in a 48 V voltage band, in particular to be charged in this band and/or to provide energy in this band. The 48 V auxiliary energy store 420 has a terminal voltage of 48 V and/or is without converters, i.e. provides the voltage in the 48 V voltage band without voltage conversion, for example as a cell voltage. The 48 V auxiliary energy store 420 thus natively provides a voltage in the 48 V voltage band.

Connections of the 48 V voltage band are highlighted in bold in FIG. 2.

The 48 V auxiliary energy store 420 may be charged for example by means of the voltage converter 240 originating from the high-voltage energy source 110. Moreover, the 48 V auxiliary energy store 420 may supply the at least one fan 220 with electrical energy in an auxiliary operating mode.

The transport refrigeration machine 2 has electrical consumers in the form of, inter alia, a starter. Moreover, at least one telematics component may be provided, which for example is part of the transport refrigeration machine 2 or else not part of the transport refrigeration machine 2.

The utility road vehicle 1 and/or the transport refrigeration machine 2 may furthermore be provided with a solar module 400 as a 48 V auxiliary energy source, for example as an alternative or in addition to the 48 V auxiliary energy store. The solar module 400 may be configured to provide electrical energy in the 48 V voltage band. By way of example, from the solar module 400 it is possible at least partly to feed at least one of the at least one fan or the at least one fan 220 and/or to charge the 48 V auxiliary energy store.

The transport refrigeration machine 2 may furthermore comprise a control device 250, for example in accordance with the third exemplary aspect. The control device 250 may be connected to at least one of the fans 220, for example. The connection between the control device 250 and the fan 220 may be in particular a communication connection, in particular a control connection. A control connection enables the control device 250 to influence the fan 220. A control connection does not presuppose a direct physical connection between the components. By way of example, a control connection may be made possible as a data connection, for example via a data bus. The control device 250 may control the fan 220. The control device 250 may switch off and/or switch on in particular at least one fan 220 of the transport refrigeration machine 2. By way of example, the control device 250 may regulate at least one fan 220 in terms of the air intensity thereof, for example in terms of the rotational speed thereof, in particular may set it to a predefined value and/or may increase and/or reduce the instantaneous rotational speed.

The control device 250 may comprise at least one input, for example. By way of example, the control device 250 may be connected to a sensor, in particular to a temperature sensor. Moreover, the control device 250 may be connected to the 48 V auxiliary energy store 420 and/or the solar module 400. By way of example, the control device 250 may receive information about the state of charge of the 48 V auxiliary energy store and/or about the present solar power of the solar module 400.

The control device 250 may influence the at least one cold-generating component 230 of the transport refrigeration machine 2. By way of example, the control device 250 may control a cooling power of the at least one cold-generating component 230 of the transport refrigeration machine 2 depending on the temperature detected by the temperature sensor. The cooling power may be determined for example as the heat transported out of an interior space to be cooled, per unit time. By way of example, the deviation between the temperature detected by the temperature sensor and a setpoint temperature may be determined and a cooling power of the cold-generating component 230 may be set depending on this deviation. The cooling power may correspond for example to the power of the cold-generating component, in particular to the effective cooling power or else to the electrical power consumed. The control of the at least one fan 220 by the control device 250 may likewise take place depending on a temperature received from the at least one temperature sensor.

By way of example, the control device 250 may be configured to control the temperature-influencing components of the transport refrigeration machine, in particular the cooling circuit 230, in particular the motor 231, based on an auxiliary power provided by the 48 V auxiliary energy store and/or the solar module 400 (e.g. jointly). By way of example, a cooling power of the cooling circuit may be increased if an increased auxiliary power is present, for example in a boost mode.

The control device 250 may be operatively connected to the high-voltage energy source 110, for example. By way of example, the control device 250 may switch off the high-voltage energy source 110 and/or configure the latter in such a way that this source provides no electrical power if the temperature-influencing components of the transport refrigeration machine 2 are deactivated, for example especially if an auxiliary power is sufficient for supplying at least one of the at least one fan 220, in particular the at least one evaporator fan. By way of example, the control device may control high-voltage energy source and 48 V auxiliary energy source in such a way that the power provided jointly by them is sufficient for supplying the at least one (evaporator) fan 220 or corresponds to the power consumption thereof. In particular, such control may take place in the partial-load mode.

The control device 250 may likewise be configured to control the voltage converter 240. By way of example, a power transferred from the high-voltage band into the 48 V voltage band may be set via the voltage converter 240. By way of example, it is thereby possible to set an electrical power which is supplied to the at least one fan 220 originating from the high-voltage energy source 110. By way of example, it is thereby possible to set a charging power for the 48 V auxiliary energy store 420. In particular, the charging power of the electrical energy store 420 may be set by the voltage converter 240 by way of the control device 250 depending on a state of charge of the 48 V auxiliary energy store.

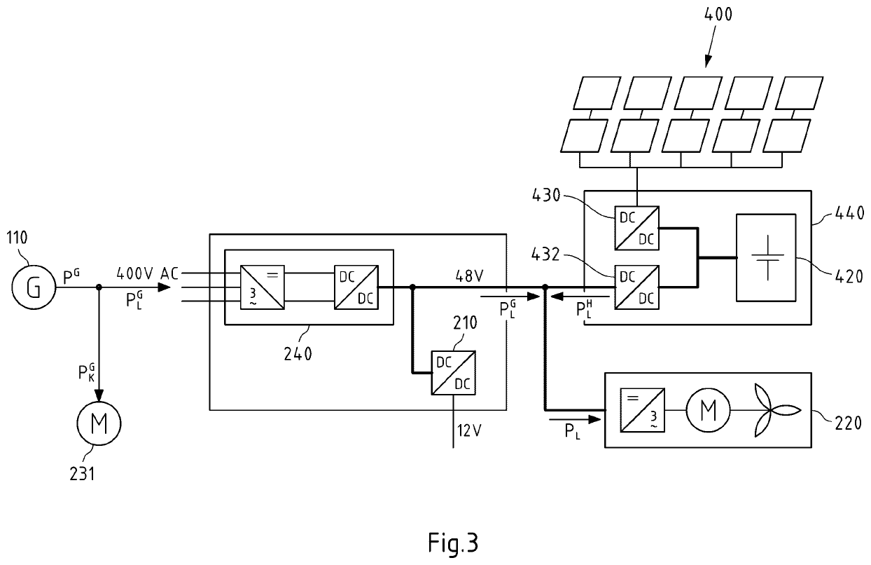

FIG. 3 shows a setup which is similar to that in FIG. 2 and in which some further details and power flows are depicted.

An electrical power in a high-voltage band, designated by P^{G}, is once again provided from the high-voltage energy source 110. From this power, at least one temperature-influencing component, in particular the motor 231 shown, is supplied with a power

$${P}_{K}^{G} .$$

The remaining power

$${P}_{L}^{G} = {P}^{G} - {P}_{K}^{G}$$

is passed to the voltage converter 420, which functions as a power supply unit for the 48 V voltage band and provides this power (according to its efficiency and apart from optional further voltage converters such as the DC voltage converter 210 to 12 V) in the 48 V voltage band.

The at least one fan 220 takes up a fan power P_{L}. By way of example, the fan 220 as shown, originating from the 48 V voltage band, may convert a 48 V DC voltage into a (three-phase) AC voltage in order to feed the latter to the fan's motor. The fan power may be provided firstly by the high-voltage energy source 110 (with power

$${P}_{L}^{G} )$$

and/or by the 48 V auxiliary energy source, in particular by the at least one solar module 400 and/or the 48 V auxiliary energy store 420 (with auxiliary power

$${P}_{L}^{H} ) : {P}^{L} = {P}_{L}^{H} + {P}_{L}^{G} .$$

Connections of the 48 V voltage band are highlighted in bold in FIG. 3.

It has been recognized that in a partial-load mode the entire fan power may be provided by the 48 V auxiliary energy source. Furthermore, it has been recognized that an at least partial supply of the at least one fan 220 enables a larger proportion of the total power of the high-voltage energy source 110 P^{G} to be passed to the temperature-influencing components.

FIG. 3 shows one exemplary configuration of the 48 V auxiliary energy source. A solar module 400 having solar panels 410 is connected to a 48 V auxiliary energy store 420 via a DC voltage converter 430. By way of example, the DC voltage converter 430 may be configured to create a voltage in the 48 V voltage band from a (e.g. temporally variable) solar voltage and/or to carry out maximum power point tracking (MPPT) of the photovoltaic module 400. Moreover, the DC voltage converter 430 may be configured to generate a charging voltage of above 48 V (e.g. still in the 48 V voltage band) (e.g. 50 V) in order to charge the energy store. Similarly to this, originating from a 48 V voltage provided by the voltage converter 240, a DC voltage converter 432 may generate an increased charging voltage for the 48 V auxiliary energy store 420. The 48 V auxiliary energy store 420 may function for example as a buffer for the solar module 400, e.g. in order to take up solar energy in phases of increased insolation and to output it later.

Alternatively, the DC voltage converter 430 and/or the DC voltage converter 432 may be omitted.

The solar module 400 and the 48 V auxiliary energy store 420 may be connected in parallel, for example.

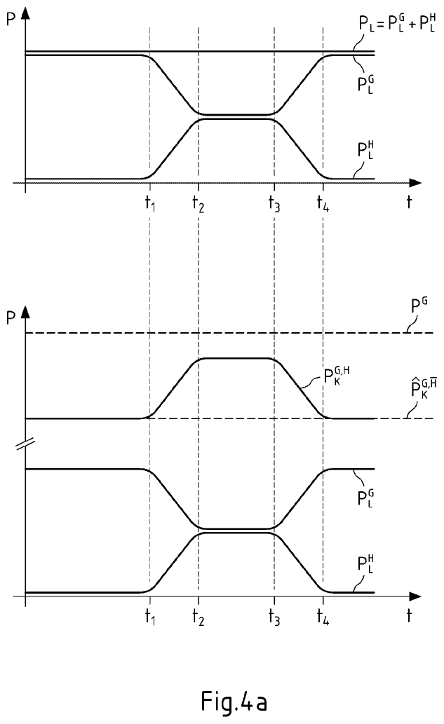

FIGS. 4a and 4b show power flows over time in two exemplary auxiliary operating modes. The designations correspond to those in FIG. 3.

FIG. 4a shows a boost mode. One or more fans are operated with a fan power P^{L} which (see above) corresponds to the sum of the auxiliary power and the fan power provided by the high-voltage energy source:

$${P}^{L} = {P}_{L}^{H} + {P}_{L}^{G} .$$

Before a point in time t₁ the auxiliary power is

$${P}_{L}^{H} = 0 ,$$

and so

$${P}_{L}^{G} = {P}^{L}$$

holds true. Afterward, between t₁ and t₂, the
auxiliary power rises and stays at a plateau value starting from t₂. Since the fan power in the example shown remains unchanged during this change (until t₂ and also beyond that), the power provided by the high-voltage energy source may be reduced by the absolute value of the auxiliary power

$${P}_{L}^{H}$$

to

$${P}_{L}^{G} = {P}_{L} - {P}_{L}^{H} ,$$

without the at least one fan being undersupplied. Starting from t₃ until t₄ the auxiliary power

$${P}_{L}^{H}$$

decreases to 0 again, and so

$${P}_{L}^{G}$$

rises to P_{L} again.

As shown in the lower part of FIG. 4a, the reduction of the power to be provided by the high-voltage energy source for the at least one fan

$${P}_{L}^{G}$$

has effects for the temperature-influencing components of the transport refrigeration machine. In the time period t₁ to t₄, in particular t₂ to t₃, the at least one temperature-influencing component may be operated with increased power. This is because the total power provided by the high-voltage energy source is divided into a power for the at least one fan

$${P}_{L}^{G}$$

and a power for the temperature-influencing components

$${P}_{K}^{G} .$$

To put it another way, the power required by the at least one fan limits the power maximally obtainable by the temperature-influencing components to the auxiliary energy source-independent maximum power

$${\hat{P}}_{K}^{G} = {\hat{P}}^{G} - {P}_{L}^{G} .$$

The circumflex here indicates a respective maximum value.

Without a 48 V auxiliary energy source, the high-voltage energy source has to operate the at least one fan, such that

$${P}_{L}^{G} = {P}_{L} .$$

The power maximally providable by the high-voltage energy source for the at least one fan is thus

$${\hat{P}}_{K}^{G , \overline{H}} = {\hat{P}}^{G} - {P}_{L}$$

without an auxiliary energy source. However, since with an auxiliary energy source

$${P}_{L}^{G} = {P}_{L} - {P}_{L}^{H}$$

then holds true, i.e. at least part of the fan power P_{L} is provided by the auxiliary energy source as

$${P}_{L}^{H} ,$$

the power maximally obtainable by the temperature-influencing components from the high-voltage energy source increases to

$${\hat{P}}_{K}^{G , H} = {\hat{P}}^{G} - ( {P}_{L} - {P}_{L}^{H} ) = ( {\hat{P}}^{G} - {P}_{L} ) + {P}_{L}^{H} = {\hat{P}}^{G , \overline{H}} + {P}_{L}^{H} .$$

The temperature-influencing components may thus be operated with a maximum power

$${\hat{P}}_{K}^{G , H}$$

increased essentially by the auxiliary power (e.g. plus avoided transformation losses from the high-voltage band into the 48 V voltage band).

The increase in the power in the high-voltage band that is available for the temperature-influencing components is possible as a result of an infeed of auxiliary power in the 48 V band. The latter is more cost-effective and safer than an infeed of further energy in the high-voltage band.

FIG. 4b shows by contrast a partial-load mode. In this case, the at least one fan may be supplied by the high-voltage energy source for example until the point in time t₁. Starting from t₁ the temperature-influencing components are shut down. Parts of the fans, too, may be deactivated, in particular the at least one condenser fan and/or the high-voltage energy store fan. In this case, the sole remaining consumer may be the evaporator fan, with a power consumption P′_{L} which is significantly less than a previous power consumption (for t<t₁) of the temperature-influencing components together with the rest of the fans.

Without a 48 V auxiliary energy source, the high-voltage energy source (e.g. generator) would have to provide the power for the at least one evaporator fan. However, the minimum possible power that the high-voltage energy source may supply is often significantly greater than the power required by the fans (e.g. the at least one evaporator fan).

The 48 V auxiliary energy source may be used to provide the fan power for the at least one evaporator fan in the partial-load mode. As a result, it is possible to switch off the high-voltage energy source (e.g. generator), and so the power originating therefrom decreases to 0. This process is illustrated in FIG. 4b.

By way of example, in the phase before t₁ a 48 V auxiliary energy store may be charged (e.g. from the high-voltage energy source and/or a solar module) in order to provide the fan power P′_{L} during the partial-load mode. Alternatively or additionally, a solar module may provide the fan power P′_{L}, for example in combination with a discharge of a 48 V auxiliary energy store.

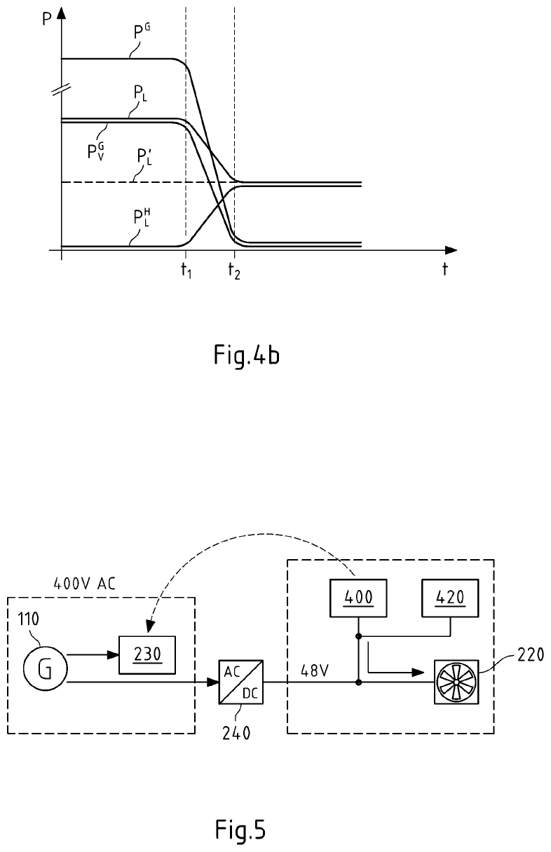

FIG. 5 illustrates the principle of action of the auxiliary operating mode, in particular of the boost mode. As a result of an infeed of electrical auxiliary power from the 48 V auxiliary energy source, in particular the solar module 400 and/or the 48 V auxiliary energy store, in the 48 V voltage band and a supply of the at least one fan 220 with electrical power, the loading on the high-voltage energy source 110 may indirectly be relieved. The energy source 110 may thus be completely switched off (e.g. in the partial-load mode) or operate the temperature-influencing components, in particular the cooling circuit 230, with particularly high power. This does not necessitate a power flow originating from the 48 V voltage band (e.g. via the voltage converter 240) into the high-voltage band of the high-voltage energy source 110.

The exemplary embodiments of the present invention that are described in this specification should also be understood as disclosed in all combinations with one another. In particular, the description of a feature that an embodiment comprises should also not—unless explicitly stated to the contrary—be understood in the present case to mean that the feature is indispensable or essential for the function of the exemplary embodiment. The sequence of the method steps outlined in this specification in the individual flowcharts is not mandatory; alternative sequences of the method steps are conceivable—unless indicated otherwise. The method steps may be implemented in various ways, and so implementation using software (by way of program instructions), hardware or a combination of the two is conceivable for implementing the method steps.

Terms used in the patent claims such as “comprise”, “have”, “include”, “contain” and the like do not exclude further elements or steps. The wording “at least partly” encompasses both the “partly” case and the “completely” case. The wording “and/or” should be understood to the effect that both the alternative and the combination are intended to be disclosed, that is to say that “A and/or B” means “(A) or (B) or (A and B)”. In the context of this specification, a plurality of units, persons or the like means multiple units, persons or the like. The use of the indefinite article does not exclude a plurality. A single component may perform the functions of a plurality of units or devices specified in the claims. Reference signs indicated in the patent claims should not be regarded as limitations for the means and steps used.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A utility road vehicle comprising:
a transport refrigeration machine comprising:
(i) at least one fan, wherein the at least one fan is configured to be operated with electrical energy in a 48 V voltage band,
(ii) at least one temperature-influencing component, configured for regulating the temperature of a cargo space of the utility road vehicle, wherein the at least one temperature-influencing component is configured to be supplied with electrical energy in a high-voltage band,
(iii) a high-voltage energy source, wherein the high-voltage energy source is configured to supply at least one of the at least one temperature-influencing component of the transport refrigeration machine and the at least one fan with electrical energy,
a 48 V auxiliary energy source, wherein the 48 V auxiliary energy source is configured to provide electrical energy at an auxiliary power in the 48 V voltage band, wherein the 48 V auxiliary energy source is configured to supply at least one of the at least one fan with electrical energy,
wherein the utility road vehicle is configured to keep the at least one temperature-influencing component free of an electrical energy supply by the 48 V auxiliary energy source,
wherein the utility road vehicle is configured to supply at least one of the at least one fan with electrical energy at least partly originating from the 48 V auxiliary energy source in an auxiliary operating mode.

2. The utility road vehicle according to claim 1, wherein the auxiliary operating mode corresponds to a boost mode in which at least one of the at least one temperature-influencing component is supplied with electrical energy originating from the high-voltage energy source.

3. The utility road vehicle according to claim 1, wherein the auxiliary operating mode corresponds to a partial-load mode in which the at least one temperature-influencing component is deactivated and/or the high-voltage energy source provides no power.

4. The utility road vehicle according to claim 1, wherein
the at least one fan comprises at least one evaporator fan, at least one condenser fan and/or at least one high-voltage energy source fan, and wherein
in the partial-load mode the at least one of the at least one fan which is supplied with electrical energy originating from the 48 V auxiliary energy source comprises at least the evaporator fan, in particular wherein the condenser fan and/or the high-voltage energy source fan are/is free of supply with electrical energy originating from the 48 V auxiliary energy source and/or
in the boost mode the at least one of the at least one fan which is supplied with electrical energy originating from the 48 V auxiliary energy source comprises at least the evaporator fan and at least one of condenser fan and/or the high-voltage energy source fan.

5. The utility road vehicle according to claim 1, wherein the utility road vehicle is configured
to control at least one of the at least one temperature-influencing component depending on the auxiliary power, in particular in such a way that a power consumption of the temperature-influencing component is increased as the auxiliary power rises, and/or
to operate the at least one temperature-influencing component at least temporarily with a power which lies above an auxiliary energy source-independent maximum temperature-regulating power of the high-voltage energy source by a surplus power, wherein the surplus power is dependent on the auxiliary power, in particular rises as the auxiliary power rises, and/or at least essentially corresponds to the auxiliary power.

6. The utility road vehicle according to claim 1, wherein the utility road vehicle is configured
to supply the at least one fan originating from the high-voltage energy source with a power which lies below a power consumption of the at least one fan by a deficit power, in particular wherein the absolute value of the deficit power corresponds to that of the surplus power and/or that of the auxiliary power, and/or
to control the high-voltage energy source depending on the auxiliary power, in particular in such a way that a power output of the high-voltage energy source is reduced as the auxiliary power rises.

7. The utility road vehicle according to claim 1, wherein the utility road vehicle is configured to feed the auxiliary power completely to the at least one of the at least one fan which is supplied with electrical energy originating from the 48 V auxiliary energy source.

8. The utility road vehicle according to claim 1, wherein the 48 V auxiliary energy source comprises at least one solar module, in particular wherein the solar module comprises a voltage converter, in particular wherein the voltage converter is configured to convert a solar-side voltage into the 48 V voltage band.

9. The utility road vehicle according to claim 1, wherein the 48 V auxiliary energy source comprises at least one 48 V auxiliary energy store.

10. The utility road vehicle according to claim 8, wherein the auxiliary power
corresponds to an instantaneous power of the solar module,
corresponds to an instantaneous discharge power of the auxiliary energy store,
corresponds to an instantaneous power of the solar module minus a charging power of the auxiliary energy store, and/or
corresponds to an instantaneous power of the solar module plus a discharge power of the auxiliary energy store.

11. The utility road vehicle according to claim 1, wherein
the utility road vehicle is configured, in a charging mode, to feed a power originating from the high-voltage energy source into the 48 V voltage band, wherein the power lies above the power consumption of the at least one fan by a charging power in order to charge the 48 V auxiliary energy store with the charging power.

12. The utility road vehicle according to claim 11, wherein
the charging power is set based on a predicted energy demand of the transport refrigeration machine.

13. The utility road vehicle according to claim 1, wherein the utility road vehicle comprises at least one trailer for utility road vehicles or is such a trailer.

14. A method for operating a utility road vehicle, according to claim 1, wherein the utility road vehicle comprises a transport refrigeration machine with at least one fan, wherein the at least one fan is configured to be operated with electrical energy in a 48 V voltage band, with at least one temperature-influencing component, configured for regulating a temperature of a cargo space of the utility road vehicle, wherein the at least one temperature-influencing component is configured to be supplied with electrical energy in a high-voltage band, and with a high-voltage energy source, wherein the high-voltage energy source is configured to supply at least one of the at least one temperature-influencing component of the transport refrigeration machine and the at least one fan (220) with electrical energy, wherein the utility road vehicle furthermore comprises a 48 V auxiliary energy source wherein the 48 V auxiliary energy source is configured to provide electrical energy at an auxiliary power in the 48 V voltage band, wherein the 48 V auxiliary energy source is configured to supply at least one of the at least one fan with electrical energy, wherein the method comprises
keeping the at least one temperature-influencing component free of an electrical energy supply by the 48 V auxiliary energy source,
supplying, in an auxiliary operating mode, at least partly, at least one of the at least one fan with electrical energy originating from the 48 V auxiliary energy source.

15. An apparatus comprising means configured for controlling and/or performing a method according to claim 14.
